(19) United States
(12) Patent Application Publication
(10) Pub. No.: US 2023/0198215 A1
(43) Pub. Date: Jun. 22, 2023

(54) LASER SYSTEM AND METHOD

(71) Applicant: Laser Quantum Limited, Stockport (GB)

(72) Inventors: Stephen Morrall, Stockport (GB); Jean-Charles Cotteverte, Stockport (GB); Alexander Ayres, Stockport (GB); Christopher Harris, Stockport (GB); Alan Cox, Stockport (GB); Jonas Hellstrom, Stockport (GB)

(73) Assignee: Laser Quantum Limited, Stockport (GB)

(21) Appl. No.: 18/155,362

(22) Filed: Jan. 17, 2023

Related U.S. Application Data
(63) Continuation of application No. PCT/GB22/52982, filed on Nov. 24, 2022.

(30) Foreign Application Priority Data
Dec. 17, 2021 (GB) 2118439.5

(51) Int. Cl. H01S 3/00; G02F 1/39

(52) U.S. Cl. CPC H01S 3/0092; G02F 1/39

(57) ABSTRACT

A laser system comprising a gain medium configured to amplify incident electromagnetic radiation and a nonlinear optical element configured to convert electromagnetic radiation amplified by the gain medium to a shorter wavelength. The laser system is configured to introduce mode competition and nonlinear effects such that the nonlinear optical element produces output electromagnetic radiation having a frequency spectrum comprising a first peak formed of a first group of frequencies and a second peak formed of a second group of frequencies. A trough separates the first and second peaks. The first and second peaks are the only dominant peaks in the frequency spectrum. The output electromagnetic radiation has a coherence curve comprising a contrast ratio of less than about 0.1 at an optical path difference that is within the inclusive range of about 1.5 mm to about 2.5 mm.

### TECHNICAL FIELD OF THE DISCLOSURE

The disclosure relates to a laser system and method.

### BACKGROUND OF THE DISCLOSURE

Some conventional laser systems produce output electromagnetic radiation having a narrow frequency spectrum, or a long coherence length (e.g. single longitudinal mode lasers). Other conventional laser systems produce output electromagnetic radiation having a broadband frequency spectrum, or a short coherence length (e.g. laser diodes). It may be desirable to provide a laser system that produces output electromagnetic radiation having a frequency spectrum and/or coherence properties that are different to those of conventional laser systems. It may be desirable to control the frequency spectrum and/or coherence properties of the output electromagnetic radiation.

It is an aim of the present disclosure to provide a laser system and method that address one or more of the problems above or at least provides a useful alternative.

### SUMMARY

According to an aspect of the present disclosure, there is provided a laser system comprising a gain medium configured to amplify incident electromagnetic radiation and a nonlinear optical element configured to convert electromagnetic radiation amplified by the gain medium to a shorter wavelength. The laser system is configured to introduce mode competition and nonlinear effects such that the nonlinear optical element produces output electromagnetic radiation having a frequency spectrum. The frequency spectrum comprises a first peak formed of a first group of frequencies, a second peak formed of a second group of frequencies, and a trough that separates the first and second peaks. The first and second peaks are the only dominant peaks in the frequency spectrum.

Conventional laser systems produce output electromagnetic radiation either having a long coherence length (e.g. monochromatic or single longitudinal mode lasers) or a short coherence length (e.g. laser diodes). That is, conventional laser systems produce output electromagnetic radiation at one of two extremes, either having a narrow frequency spectrum (e.g. comprising a single sharp peak) or a broad frequency spectrum (e.g. a rough or noisy pattern comprising many sharp peaks or a single, relatively flat, broadband mound).

Embodiments disclosed herein have taken a relatively incoherent, broadband laser system and improved a coherence of the output electromagnetic radiation by using controlled mode competition (e.g. gain saturation and/or spatial hole burning) and nonlinear effects (e.g. sum frequency generation and/or sum frequency mixing) to produce two separated groups of successfully lasing frequencies that form the first and second dominant peaks in the frequency spectrum. The first and second dominant peaks are separated by a trough associated with a group of unsuccessful or less successful frequencies. An unexpected and surprising result that a frequency spectrum comprising first and second dominant peaks separated by a trough provides coherence properties that are not attainable using known laser systems has been found. That is, embodiments disclosed herein have created a new type of laser beam having new coherence properties that exist in the previously unoccupied technical region between single mode lasers and broadband diode lasers. This advantageously allows the laser system to be used in applications that were previously not compatible with or suitable for known laser systems.

It will be appreciated that discussion of coherence properties of the output electromagnetic radiation refers to temporal coherence rather than spatial coherence.

The first peak and/or the second peak and/or the trough may be generally symmetrical. A width of the trough may be greater than a width of either of the first and second peaks. That is, a separation between the first and second peaks may be greater than a width of either of the first and second peaks.

The first peak and/or the second peak may have the general shape of an inverted “V”. The trough may have the general shape of a “U”. Summits of the first and second peaks may be more pointed than a base of the trough. A base of the trough may be flatter than summits of the first and second peaks.

A lowest intensity of the frequency spectrum at the trough may be non-zero. That is, the frequency spectrum may not reach an intensity of zero between the first and second peaks. A group of frequencies associated with the trough that is relatively unsuccessful in terms of mode competition still contributes to the intensity of the output electromagnetic radiation.

The first and second peaks may correspond to envelopes of the spectrum. The first peak may be generally smooth. The second peak may be generally smooth. The trough may be generally smooth. By “generally smooth” it will be understood that, depending on a given resolution of measurement, any portion of a frequency spectrum may comprise some noise-like patterns in the form of erratic sub-peaks and sub-troughs. However, according to the laser system of the present disclosure, the presence of said sub-peaks and sub-troughs do not disturb the generally symmetrical shapes of the first peak and/or the second peak and/or the trough. Thus, the first peak and/or the second peak and/or the trough may be described as being generally smooth.

The first and second peaks are the only dominant peaks in the frequency spectrum. That is, the first and second peaks comprise the greatest intensities of the frequency spectrum, and no other peak in the frequency spectrum has the same or a similar intensity to either of the first and second peaks. For example, the first and second peaks may have intensities that are at least double the intensity of any other peak in the frequency spectrum.

A wavelength at maximum of the first peak may be about 531.95 nm or more. A wavelength at maximum of the second peak may be about 532.40 nm or less. A FWHM of the first peak and/or the second peak may be about 0.035 nm or more. A FWHM of the first peak and/or the second peak may be about 0.045 nm or less.

A peak-to-peak spacing between the first and second peaks may be about 0.05 nm or more. A peak-to-peak spacing between the first and second peaks may be about 0.10 nm or less.

An intensity at the maximum of the first peak may be within about 20% of an intensity at the maximum of the second peak. An intensity at the maximum of the first peak may be substantially equal to an intensity at the maximum of the second peak.

An average intensity across the trough that separates the first and second peaks may be about 50% or more lower than an average intensity at the maxima of the first and second peaks. An average intensity across the trough that separates the first and second peaks may be about 80% or less lower than an average intensity at the maxima of the first and second peaks.

The laser system may comprise first and second end mirrors arranged to form an optical cavity containing the gain medium and the nonlinear optical element. That is, the laser system may be configured to perform intra-cavity frequency conversion of the electromagnetic radiation amplified by the gain medium to a shorter wavelength.

The laser system may be configured such that the nonlinear optical element produces output electromagnetic radiation having a coherence curve comprising a contrast ratio of less than about 0.1 at an optical path difference that is within the inclusive range of about 1.5 mm to about 2.5 mm.

The gain medium may be configured to produce infrared electromagnetic radiation. The infrared electromagnetic radiation may have a wavelength of about 1064 nm.

The nonlinear optical element may comprise lithium triborate. The nonlinear optical element may be configured to produce electromagnetic radiation having at least half the wavelength of the electromagnetic radiation generated by the gain medium. The nonlinear optical element may be configured to convert the infrared electromagnetic radiation to electromagnetic radiation having a wavelength of about 532 nm.

According to an aspect of the present disclosure, there is provided a laser system comprising a gain medium configured to amplify incident electromagnetic radiation and a nonlinear optical element configured to convert electromagnetic radiation amplified by the gain medium to a shorter wavelength. The laser system is configured such that the nonlinear optical element produces output electromagnetic radiation having a coherence curve comprising a contrast ratio of less than about 0.1 at an optical path difference that is within the inclusive range of about 1.5 mm to about 2.5 mm.

Embodiments disclosed herein have taken a relatively incoherent, broadband laser system and improved a coherence of the output electromagnetic radiation by using controlled mode competition (e.g. spatial hole burning) and nonlinear effects (e.g. sum frequency generation) to produce output electromagnetic radiation having a coherence curve comprising a contrast ratio of less than about 0.1 at an optical path difference that is within the inclusive range of about 1.5 mm to about 2.5 mm. The coherence curve demonstrates the coherence properties of the output electromagnetic radiation produced by the laser system. This coherence curve is previously unknown to laser systems. That is, in one or more embodiments, a new type of laser beam is created that has coherence properties that exist in the previously unoccupied area between single mode lasers and broadband diode laser. This advantageously allows the laser system to be used in applications that were previously not compatible with or suitable for lasers.

The coherence curve of the output electromagnetic radiation may correspond to the contrast ratio of the output electromagnetic radiation plotted as a function of the optical path difference of an interferometer used to measure coherence properties of the output electromagnetic radiation. The contrast ratio may correspond to a visibility of fringes of an interference pattern formed by the output electromagnetic radiation and measured by the interferometer. It will be appreciated that, whilst an interferometer may be used to measure the coherence properties of the output electromagnetic radiation, the presence of the interferometer itself is not required for the laser system disclosed herein to produce output electromagnetic radiation having novel and beneficial coherence properties.

The contrast ratio may be defined by the following equation:

$$CR = \frac{{I}_{max} - {I}_{min}}{{I}_{max} + {I}_{min}}$$

where Imax is a maximum intensity of the interference pattern and Imin is a minimum intensity of the interference pattern.

The coherence curve may be defined by the following equation:

$$CR ( OPD ) = \frac{\vert {\sum }_{n = n min}^{n max} {S}_{n} {e}^{i 2 π \frac{OPD}{{λ}_{n}}} \vert}{{\sum }_{n = n min}^{n max} {S}_{n}}$$

where CR is the contrast ratio of the output electromagnetic radiation, OPD is the optical path difference of the interferometer, n is an integer, S is an intensity of the output electromagnetic radiation and λ is a wavelength of the output electromagnetic radiation. A plot of Sₙ versus λₙ may correspond to a spectrum of the output electromagnetic radiation.

The laser system may be configured to introduce mode competition and nonlinear effects such that the nonlinear optical element produces output electromagnetic radiation having a frequency spectrum comprising a first peak formed of a first group of frequencies, a second peak formed of a second group of frequencies, and a trough that separates the first and second peaks, wherein the first and second peaks are the only dominant peaks in the frequency spectrum.

The laser system described in the above aspects may comprise any of the following features.

The laser system may be a continuous wave laser system. That is, the laser system may produce the output electromagnetic radiation via continuous wave operation rather than being a pulsed or mode-locked laser.

The laser system may comprise first and second end mirrors arranged to form an optical cavity containing the gain medium and the nonlinear optical element. The gain medium may be positioned between the first end mirror and a centre of the optical cavity such that a gap between the gain medium and the first end mirror is smaller than a gap between the gain medium and the centre of the optical cavity.

The position of the gain medium and/or the nonlinear optical element may be configured to increase coupling between laser modes of the electromagnetic radiation to at least partially determine a form of the first and second peaks.

The gap between the gain medium and the first end mirror may be about 0.8 mm or more.

The gap between the gain medium and the first end mirror may be about 1.4 mm or less.

The laser system may comprise an actuator configured to adjust the position of the gain medium within the optical cavity.

The actuator may be configured to adjust the position of the gain medium within the optical cavity by about 0.1 mm or more. The actuator may be configured to adjust the position of the gain medium within the optical cavity by about 1 mm or less.

The laser system may comprise a controller configured to control an operating parameter of the gain medium and/or the nonlinear optical element to at least partially determine a form of at least one of the first and second peaks.

The laser system may comprise an optical pump source configured to provide pump electromagnetic radiation to the gain medium. The controller may be configured to control the optical pump source. The operating parameter may comprise a wavelength of the pump electromagnetic radiation.

The power of the pumping electromagnetic radiation may at least partially determine a width of the electromagnetic spectrum.

The controller may be configured to increase the pump power to broaden the electromagnetic spectrum.

The gain medium may be configured to absorb between about 2 W and about 7 W of the pumping electromagnetic radiation.

The laser system may comprise a heating system configured to adjust a temperature of the gain medium. The controller may be configured to control the heating system. The operating parameter may comprise the temperature of the gain medium.

The temperature of the gain medium may at least partially determine a width of the spectrum.

The controller may be configured to increase the temperature of the gain medium to broaden the spectrum.

The controller may be configured to increase the temperature of the gain medium to increase the separation between the first and second peaks (i.e. to increase a width of the trough between the first and second peaks).

The controller may be configured to set the temperature of the gain medium to between about 40° C. and about 80° C.

The controller may be configured to set the temperature of the gain medium to about 60° C.

The laser system may comprise a heater configured to adjust a temperature of the nonlinear optical element. The controller may be configured to control the heater. The operating parameter may comprise the temperature of the nonlinear optical element.

The temperature of the nonlinear optical element may at least partially determine a ratio between the heights or intensities of the first and second peaks.

The controller may be configured to adjust the temperature of the nonlinear optical element to adjust the ratio between the heights or intensities of the first and second peaks.

The heating system and the heater may be the same component.

The controller may be configured to set the temperature of the nonlinear optical element to between about 35° C. and about 55° C.

The laser system may comprise a spectrometer configured to measure a value that is indicative of a coherence of the output electromagnetic radiation. The controller may be configured to control the operating parameter such that the value is in a predetermined range.

The spectrometer may be a Fourier transform interferometer. The spectrometer may be a Michelson interferometer.

The value may at least partially depend on a contrast ratio of the output electromagnetic radiation.

The value may at least partially depend on an optical path difference of the interferometer.

The value may be indicative of a coherence curve of the output electromagnetic radiation. The coherence curve may be defined as the contrast ratio of the output electromagnetic radiation as a function of the optical path difference of the interferometer.

The controller may be configured to control the operating parameter such that the coherence curve satisfies a predetermined requirement.

The controller may be configured to control the operating parameter such that a contrast ratio of the output electromagnetic radiation is less than a predetermined value when the optical path difference of the interferometer is within a predetermined range.

An angle between an optical axis of the nonlinear optical element and a propagation axis of electromagnetic radiation incident on the nonlinear optical element may be configured to at least partially determine a form of at least one of the first and second peaks.

The angle may be an out-of-phase-matching-plane angle (e.g. a vertical angle) between an optical axis of the nonlinear optical element and a propagation axis of electromagnetic radiation incident on the nonlinear optical element.

The out-of-phase-matching-plane angle between the optical axis of the nonlinear optical element and the propagation axis of the electromagnetic radiation may be about 4° or more.

The laser system may comprise an actuation system configured to adjust the angle between the optical axis of the nonlinear optical element and the propagation axis of the electromagnetic radiation.

At least one of the first and second end mirrors may comprise a concave reflective surface configured to reflect the electromagnetic radiation.

The gain medium may comprise one of the following crystals: Nd:YVO4, Nd:GdVO4, Nd:YAG, Nd:YAP, Nd:YLF, Nd:KGW.

The gain medium may have a parallelepiped shape. The gain medium may have a cylindrical shape. The gain medium may have a rod shape.

The gain medium may be elongate along its optical axis. That is, a greatest distance between two ends of the gain medium may exist along its optical axis. In other words, a length (i.e. the greatest of three dimensions) of the gain medium may exist along its optical axis.

Using a gain medium that is elongate along its optical axis advantageously increases a gain of the laser system.

An average pattern of overlapping and non-overlapping antinodes along the gain medium may produce groups of successful laser modes and less successful laser modes. That is, an integration across all areas along the gain medium defines a coupling between laser modes, and at least partially determines which output frequencies are successful. As such, using a gain medium that is elongate along its optical axis advantageously encourages mode competition such that the nonlinear optical element produces output electromagnetic radiation having a desired frequency spectrum and desired coherence properties in accordance with the first and second aspects of the present disclosure.

Using a gain medium that is elongate along its optical axis may advantageously contribute to a lowest point of the trough being associated with a non-zero intensity.

The gain medium may have a length along its optical axis of between about 4 mm and about 7 mm.

The gain medium may have a doping concentration of about 0.5%.

The gain medium may comprise one of the following dopants: Nd, Yb, Pr, Er.

According to an aspect of the present disclosure, there is provided a method of operating a laser system comprising using a gain medium to amplify incident electromagnetic radiation and using a nonlinear optical element to convert electromagnetic radiation amplified by the gain medium to a shorter wavelength. The method comprises configuring the laser system to introduce mode competition and nonlinear effects such that the nonlinear optical element produces output electromagnetic radiation having a frequency spectrum. The frequency spectrum comprises a first peak formed of a first group of frequencies, a second peak formed of a second group of frequencies, and a trough that separates the first and second peaks. The first and second peaks are the only dominant peaks in the frequency spectrum.

According to another aspect of the present disclosure, there is provided a method of operating a laser system comprising using a gain medium to amplify incident electromagnetic radiation and using a nonlinear optical element to convert electromagnetic radiation amplified by the gain medium to a shorter wavelength. The method comprises configuring the laser system such that the nonlinear optical element produces output electromagnetic radiation having a coherence curve comprising a contrast ratio of less than about 0.1 at an optical path difference that is within the inclusive range of about 1.5 mm to about 2.5 mm.

The methods of the above aspects may comprise any of the following features.

The method may comprise operating the laser system using continuous wave operation.

The method may comprise arranging first and second end mirrors to form an optical cavity containing the gain medium and the nonlinear optical element.

The method may comprise positioning the gain medium between the first end mirror and a centre of the optical cavity such that a gap between the gain medium and the first end mirror is smaller than a gap between the gain medium and the centre of the optical cavity.

The gap between the gain medium and the first end mirror may be about 0.8 mm or more.

The gap between the gain medium and the first end mirror may be about 1.4 mm or less.

The method may comprise adjusting the position of the gain medium within the optical cavity.

The method may comprise controlling an operating parameter of the gain medium and/or the nonlinear optical element to at least partially determine a form of at least one of the first and second peaks.

The method may comprise providing pumping electromagnetic radiation to optically pump the gain medium. The operating parameter may comprise a wavelength of the pump electromagnetic radiation.

The operating parameter may comprise a temperature of the gain medium.

The operating parameter may comprise a temperature of the nonlinear optical element.

The method may comprise measuring a value that is indicative of a coherence property of the output electromagnetic radiation. The method may comprise controlling the operating parameter such that the value is in a predetermined range.

The method may comprise introducing an angle between an optical axis of the nonlinear optical element and a propagation axis of the electromagnetic radiation to at least partially determine a form of at least one of the first and second peaks.

The method may comprise adjusting the angle between the optical axis of the nonlinear optical element and the propagation axis of the electromagnetic radiation.

### BRIEF DESCRIPTION OF THE DRAWINGS

Some embodiments of the disclosure will now be described by way of example only and with reference to the accompanying drawings, in which:

FIG. 1 shows an example of three different spectra of output electromagnetic radiation produced by a laser system before the laser system has been configured according to the present disclosure.

FIG. 2A schematically depicts a laser system comprising a laser and a spectrometer.

FIG. 2B shows an example graph demonstrating how an intensity of the interference pattern varies with changes in the optical path difference between the first and second arms of the laser system of FIG. 2A.

FIG. 3 shows coherence curves of the three different spectra shown in FIG. 1 along with a magnified inset view of a portion of the coherence curves.

FIG. 4A schematically depicts a laser system according to an embodiment of the present disclosure.

FIG. 4B schematically shows two laser modes oscillating in a portion of the optical cavity of FIG. 4B.

FIG. 5A shows an example of five different spectra of output electromagnetic radiation produced by laser systems according to embodiments of the present disclosure.

FIG. 5B shows coherence curves of the five different spectra shown in FIG. 5A along with a magnified inset view of a portion of the coherence curves.

FIGS. 6A-7B show examples of how a form of the first and second dominant peaks of the output electromagnetic radiation is altered when a gap between the gain medium and the first end mirror is changed.

FIG. 8 shows three spectra produced by a laser system comprising a gain medium set at three different temperatures.

FIGS. 9A-11B show example simulations of how changes to the form of the first and second dominant peaks of the spectrum of the output electromagnetic radiation alter a coherence curve of the output electromagnetic radiation.

FIG. 12A shows a flowchart of a method of operating a laser system according to an embodiment of the present disclosure.

FIG. 12B shows a flowchart of another method of operating a laser system according to an embodiment of the present disclosure.

### DETAILED DESCRIPTION

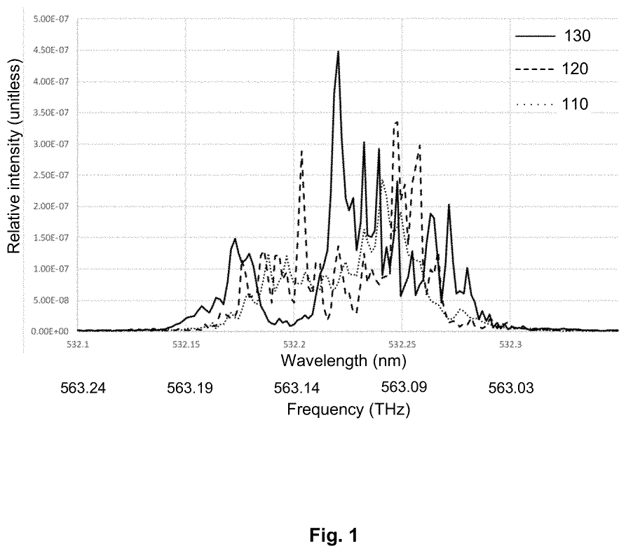

FIG. 1 shows an example of three different spectra 110-130 of output electromagnetic radiation produced by a laser system before the laser system has been configured according to the present disclosure. It will be appreciated that the spectra of FIG. 1 do not constitute prior art, and are merely provided to aid understanding of the present disclosure.

In general, spectra may be represented using units of wavelength or frequency. After appropriate conversion using the speed of light in the relevant propagation medium, units of wavelength and frequency may be interchanged. The spectra shown throughout the present disclosure are provided with units of both wavelength (nm) and frequency (THz). In the examples shown, the output electromagnetic radiation is assumed to be travelling through air. As such, a speed of light of 299,702,547 meters per second is used to convert between units of wavelength and frequency. However, the laser system disclosed herein is not limited to use in air, and the output electromagnetic radiation may travel through other media. For example, the output electromagnetic radiation may travel through vacuum, in which case a speed of light of 299,792,458 metres per second may be used to convert between units of wavelength and frequency. It will be understood that a spectrum has the same shape and temporal coherence properties regardless of whether units of wavelength or frequency are used.

The pre-configured laser system comprises a gain medium configured to amplify incident electromagnetic radiation having a wavelength of about 1064 nm. The pre-configured laser system further comprises a nonlinear optical element configured to convert the amplified electromagnetic radiation to output electromagnetic radiation having a shorter wavelength of about 532 nm. The three spectra 110-130 correspond to the use of three different pumping powers (e.g. three different currents used to pump the gain medium). A first spectrum 110 comprises wavelengths of output electromagnetic radiation between about 532.16 nm and about 532.30 nm. A second spectrum 120 comprises wavelengths of output electromagnetic radiation between about 532.16 nm and about 532.30 nm. A third spectrum 130 comprises wavelengths of output electromagnetic radiation between about 532.14 nm and about 532.30 nm. A spectrometer may be used to measure coherence properties of the output electromagnetic radiation produced by the pre-configured laser system. It will be appreciated that the spectra 110-130 contain many individual frequencies of electromagnetic radiation, and that a spacing between individual frequencies may be smaller than a resolution of a spectrometer. As such, the spectra 110-130 do not show individual frequencies, but rather envelopes containing individual frequencies. Alternatively, coherence properties of a given laser system may be determined through simulation.

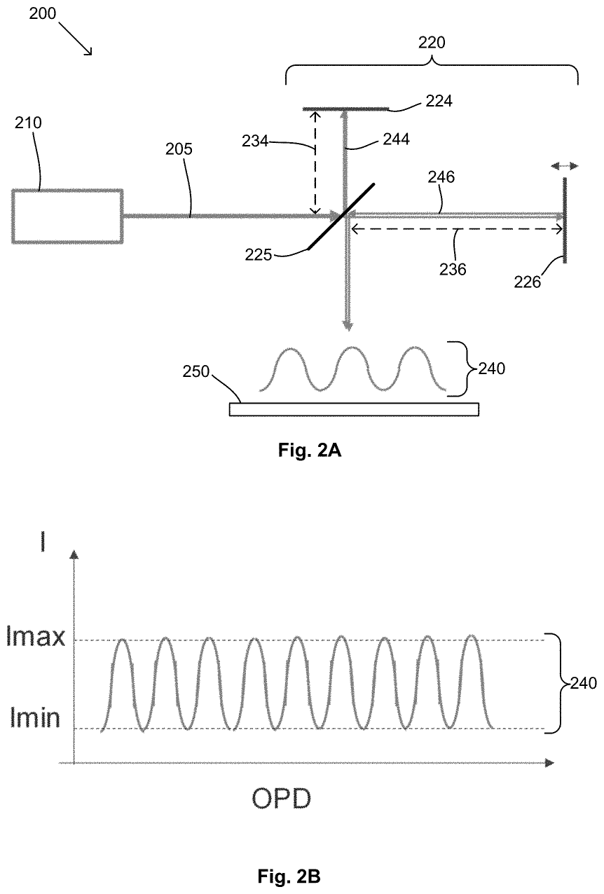

FIG. 2A schematically depicts a laser system 200 comprising a laser 210 and a spectrometer 220. In the example of FIG. 2A, the spectrometer 220 is a Fourier-transform spectrometer, based upon a Michelson interferometer, comprising a beam splitter 225, a fixed mirror 224 positioned along a first arm 234 and a movable mirror 226 positioned along a second arm 236 that is perpendicular to the first arm 234. The spectrometer 220 may be used to determine coherence properties of the output electromagnetic radiation produced by the laser 210. It will be appreciated that other forms of interferometer may be used to determine coherence properties of the laser 210. Fourier-transform interferometers 220 are well known and as such are only briefly described herein. Output electromagnetic radiation 205 produced by the laser 210 is split by the beam splitter 225 such that a first portion 244 of the output electromagnetic radiation propagates along the first arm 234 and a second portion 246 of the output electromagnetic radiation propagates along the second arm 236. The first portion 244 reflects from the fixed mirror 224 and the second portion 246 reflects from the movable mirror 226. The first and second portions 244, 246 recombine and interfere with each other to form an interference pattern 240 that is detected by a photodetector 250. The movable mirror 226 is movable along the second arm 236 to introduce and change an optical path difference between the first arm 234 and the second arm 236. Changing the optical path difference between the first arm 234 and the second arm 236 causes the first and second portions of output electromagnetic radiation 244, 246 to interfere constructively and/or destructively, thereby changing an intensity of the resulting interference pattern 240.

FIG. 2B shows an example graph demonstrating how an intensity I of the interference pattern 240 varies with changes in the optical path difference OPD between the first and second arms 234, 236 of the laser system 200 of FIG. 2A. As the moveable mirror 226 is moved and the optical path difference OPD varies, an intensity I of the interference pattern 240 varies sinusoidally between a maximum intensity Iₘₐₓ and a minimum intensity Iₘᵢₙ. A contrast ratio CR of the output electromagnetic radiation 205 may be defined by the following equation:

$$CR = \frac{{I}_{max} - {I}_{min}}{{I}_{max} + {I}_{min}}$$

The contrast ratio corresponds to a visibility (e.g. a sharpness or blurriness) of fringes of the interference pattern 240. A coherence length of the output electromagnetic radiation 205 may be defined as the smallest optical path difference OPD at which the contrast ratio is about 50%.

A coherence curve of the output electromagnetic radiation 205 may correspond to the contrast ratio of the output electromagnetic radiation 205 as a function of the optical path difference OPD between the first and second arms 234, 236 of the spectrometer 220. The coherence curve of the output electromagnetic radiation 205 may satisfy the following equation:

$$CR ( OPD ) = \frac{\vert {\sum }_{n = n min}^{n max} {S}_{n} {e}^{i 2 π \frac{OPD}{{λ}_{n}}} \vert}{{\sum }_{n = n min}^{n max} {S}_{n}}$$

where CR is the contrast ratio of the output electromagnetic radiation, OPD is the optical path difference between the first and second arms 234, 236 of the spectrometer 220, n is an integer, S is an intensity of the output electromagnetic radiation and λ is a wavelength of the output electromagnetic radiation 205. A plot of Sₙ versus λₙ may correspond to a spectrum of the output electromagnetic radiation.

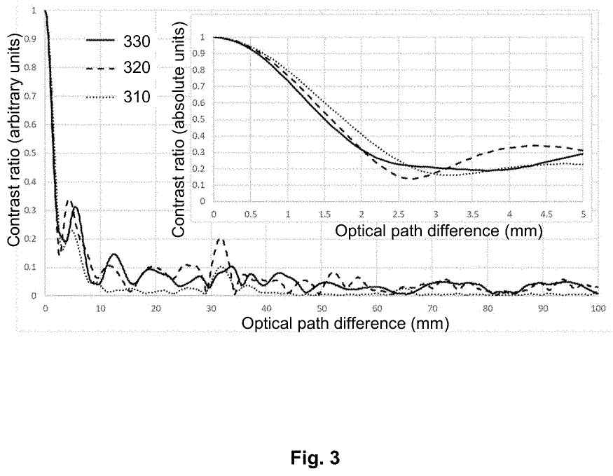

FIG. 3 shows coherence curves 310-330 of the three different spectra 110-130 shown in FIG. 1 along with a magnified inset view of a portion of the coherence curves 310-330. A first coherence curve 310 corresponds to the first spectrum 110, a second coherence curve 320 corresponds to the second spectrum 120 and a third coherence curve 330 corresponds to the third spectrum 130. As can be seen, each spectrum 110-130 has its own characteristic coherence curve 310-330. All of the coherence curves 310-330 have a contrast ratio of one at an optical path difference of zero. Each coherence curve 310-330 is unique, but all follow a similar pattern of the contrast ratio sharply decreasing to a first local minimum at an optical path difference of greater than 2.5 mm and less than 4.5 mm. The contrast ratio for each coherence curve 310-330 then oscillates as the optical path difference increases. Peaks in the contrast ratios of each of the coherence curves 310-330 generally correspond to peaks in the associated spectrum 110-130. A spacing between peaks in the coherence curves 310-330 may generally correspond to a position of the peaks in the spectra 110-130. Shorter spacing between peaks in the spectra 110-130 may generally generate peaks in the coherence curves 310-330 at greater optical path differences. Longer spacing between peaks in the spectra 110-130 (and/or a generally broad spectrum overall) may generally generate peaks in the coherence curves 310-330 at shorter optical path differences. A general trend for each coherence curve 310-330 is that the contrast ratio tends to decrease with an increasing optical path difference (i.e. heights of the peaks of the contrast ratio tend to decrease with increasing optical path difference).

It may be desirable for the output electromagnetic radiation produced by the laser 210 to have a certain frequency spectrum property and/or a coherence property. It may be desirable to provide a laser system that satisfies a predetermined coherence curve requirement that known laser systems do not provide. It may be desirable for the output electromagnetic radiation to have a contrast ratio that stays below a predetermined value across a predetermined range of optical path differences. It may be desirable to provide a laser system that produces output electromagnetic radiation having a contrast ratio that reaches a first minimum at an optical path difference of about 2.5 mm or less. It may be desirable to provide a laser system that produces output electromagnetic radiation having a contrast ratio that reaches a first minimum at an optical path difference of about 2.2 mm or less. It may be desirable to provide a laser system that produces output electromagnetic radiation having a contrast ratio that reaches a first minimum at an optical path difference of about 1.5 mm or more. It may be desirable to provide a laser system that produces output electromagnetic radiation having a first minimum of the contrast ratio at about 0.1 or less. It may be desirable to provide a laser system that produces output electromagnetic radiation having a first minimum of the contrast ratio at about 0.05 or less. As can be seen from FIG. 3, all of the coherence curves 310-330 generated by the pre-configured laser system 200 have a contrast ratio that reaches a first minimum at an optical path difference of about 2.5 mm or more. That is, none of the coherence curves 310-330 associated with the pre-configured laser system satisfy the abovementioned desirable coherence curve requirements. It may be desirable to provide a laser system that is capable of controlling a shape of the coherence curve of the output electromagnetic radiation produced by the laser system. For example, it may be desirable to provide a laser system that is capable of compressing a coherence curve of its output electromagnetic radiation such that a first minimum of the coherence curve occurs before a predetermined optical path difference.

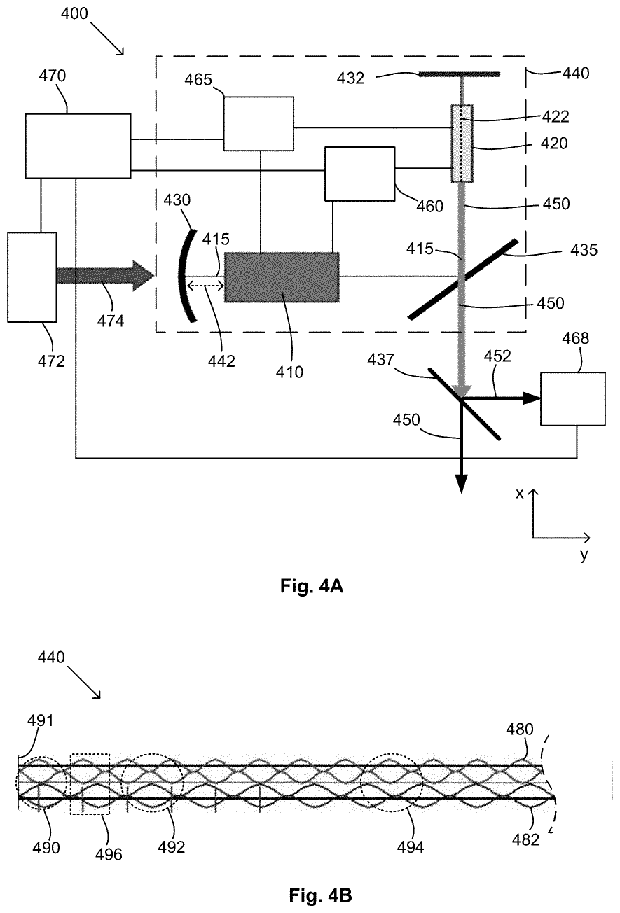

FIG. 4A schematically depicts a laser system 400 according to an embodiment of the present disclosure. The laser system 400 comprises a gain medium 410 configured to amplify incident electromagnetic radiation 415. The gain medium 410 may act to amplify infrared radiation in both directions along an optical axis of the laser system 400. The gain medium 410 may comprise a crystal such as, for example, Nd:YVO4. The gain medium may comprise other crystals, such as Nd:GdVO4, Nd:YAG, Nd:YAP, Nd:YLF, Nd:KGW, etc. The infrared electromagnetic radiation may have a wavelength of about, for example, 1064 nm.

The laser system 400 comprises a nonlinear optical element 420 configured to convert electromagnetic radiation 415 amplified by the gain medium 410 to a shorter wavelength. The nonlinear optical element 420 may comprise a crystal. The nonlinear optical element 420 may, for example, comprise lithium triborate. The nonlinear optical element 420 may comprise other materials, e.g. nonlinear crystals such as, for example, KTP, KDP, BBO, etc. The nonlinear optical element 420 may be configured to halve the wavelength of the electromagnetic radiation 415 amplified by the gain medium 410. For example, the nonlinear optical element 420 may be configured to convert the infrared electromagnetic radiation to output electromagnetic radiation 450 having a wavelength of about 532 nm. The output electromagnetic radiation 450 may, for example, be visible electromagnetic radiation, e.g. green light. As shown by the continuous output beam 450 of FIG. 4A, the laser system 400 is a continuous wave laser system. That is, the laser system 400 produces the output electromagnetic radiation 450 via continuous wave operation.

The laser system 400 comprises first and second end mirrors 430, 432 arranged to form an optical cavity 440 containing the gain medium 410 and the nonlinear optical element 420. In the example of FIG. 4A, the gain medium 410 and the nonlinear optical element 420 are arranged along perpendicular arms of the optical cavity 440, and a wavelength selective optical element 435 is provided between the gain medium 410 and the nonlinear optical element 420. The wavelength selective optical element 435 is configured to reflect electromagnetic radiation 415 amplified by the gain medium 410 and transmit output electromagnetic radiation 450 produced by the nonlinear optical element 420. Electromagnetic radiation may reflect between the end mirrors 430, 432 and make multiple passes through the optical cavity. Alternatively, one or both of the end mirrors may be removed and/or a reflective coating may be removed or changed such that the electromagnetic radiation makes a single pass through the gain medium 410 and the nonlinear optical element 420. However, only performing a single pass may require the use of higher pumping powers to reach a desired output electromagnetic radiation power.

The laser system 400 is configured to introduce mode competition and nonlinear effects such that the nonlinear optical element 420 produces output electromagnetic radiation having a frequency spectrum comprising a first peak formed of a first group of frequencies, a second peak formed of a second group of frequencies, and a trough that separates the first and second peaks. The first and second peaks are the only dominant peaks in the frequency spectrum. Wavelength at maximums of the first and second dominant peaks may include the greatest intensities in the spectrum of the output electromagnetic radiation. The laser system is also configured such that the nonlinear optical element produces output electromagnetic radiation having a coherence curve comprising a contrast ratio of less than about 0.1 at an optical path difference that is within the inclusive range of about 1.5 mm to about 2.5 mm

FIG. 4B schematically shows two laser modes 480, 482 oscillating in a portion of the optical cavity 440. Each laser mode 480, 482 comprises a standing wave formed by electromagnetic radiation 415 amplified by the gain medium 410 that is confined in the optical cavity 485 (see FIG. 4A). Electromagnetic radiation amplified by the gain medium 410 may reflect between the first and second end mirrors 430, 432 and interfere with itself. The laser modes 480, 482 correspond to wavelengths of electromagnetic radiation 415 that have nodes located at the end mirrors 430, 432 of the optical cavity 440. As mentioned above, in order to satisfy boundary conditions, all laser modes 480, 482 must comprise nodes at the end mirrors 430, 432 of the optical cavity 440. That is, the optical cavity 440 does not support the existence of laser modes that do not have nodes located at the first and second end mirrors 430, 432. The nodes and antinodes of each laser mode 480, 482 are distributed axially along a length of the optical cavity 440.

Each laser mode 480, 482 attempts to take power out of the gain medium 410 at and around the antinodes of the standing wave pattern. That is, the antinodes are the locations at which the laser modes 480, 482 interact with excited ions of the gain medium 410 (or e.g. electrons for other gain media) and thereby extract power from the gain medium 410. The laser modes 480, 482 do not take power from the gain medium 410 at nodes of the standing wave patterns. As such, the gain medium 410 is saturated preferentially at the antinodes of the laser modes 480, 482. The resulting amplification provided by the gain medium 410 is dominated by an excitation density at the antinodes of the laser modes 480, 482. Saturation of the gain medium 410 by the antinodes may be referred to as spatial hole burning.

Many laser modes 480, 482 exist within the optical cavity 440, each laser mode having a different wavelength. A wavelength separation between consecutive laser modes in infrared electromagnetic radiation may, for example, be about 8 pm. Sum frequency generation (e.g. second harmonic generation) and sum frequency mixing of laser modes in the nonlinear optical element 420 reduces the wavelength separation of the output electromagnetic radiation 450. A wavelength separation between consecutive frequencies in the visible output electromagnetic radiation 450 may, for example, be about 2 pm. In the simplified example of FIG. 4B, only two laser modes 480, 482 in the infrared with significantly different wavelengths are shown for clarity and visibility. The wavelength of the first laser mode 480 is smaller than the wavelength of the second laser mode 482. In practice, many groups of laser modes exist within the optical cavity 440 and compete with each other to take power from the gain medium 410. The groups of laser modes that perform better in extracting power from the gain medium 410 generate peaks in the frequency spectrum of the output electromagnetic radiation 450 whereas the groups of laser modes that perform worse in extracting power from the gain medium 410 do not produce peaks in the frequency spectrum of the output electromagnetic radiation 450. It is possible to configure the laser system 400 to produce two groups of powerful output frequencies that are separated by at least one group of less powerful output frequencies. Mode competition (e.g. gain saturation and/or spatial hole burning) and/or nonlinear effects (e.g. sum frequency generation and/or mixing) may be introduced and controlled to determine the successful and less successful groups of output frequencies.

At a first area 490 of the optical cavity 440 that is proximate a first end of the optical cavity 440 (i.e. the first end mirror 430), the nodes of the laser modes 480, 482 substantially overlap and the antinodes of the laser modes 480, 482 substantially overlap. That is, proximate the first end 491 of the optical cavity 440, the laser modes 480, 482 are substantially in phase. If a portion of the gain medium 410 was located proximate the first area 490 of the optical cavity 440, the portion of the gain medium 410 would be saturated in substantially the same way for the superimposed antinodes of the laser modes 480, 482. That is, the antinode of the first laser mode 480 and the antinode of the second laser mode 482 would both try to take power from the portion of the gain medium 410 at the first area 490. In other words, the antinodes of the laser modes 480, 482 are in competition with one another for the power available from the gain medium 410 at the first area 490. If, for example, the first laser mode 480 wins the mode competition and extracts power from the gain medium 410 at the first area 490, then the first laser mode 480 would lase powerfully at the first area 490 and the second laser mode 482 would not lase, or would lase less powerfully than the first laser mode 480. Alternatively, if the second laser mode 482 wins the mode competition and extracts power from the gain medium 410 at the first area 490, then the second laser mode 482 would lase powerfully at the first area 490 and the first laser mode 480 would not lase, or would lase less powerfully than the second laser mode 482. The outcome of whether the first or second laser mode 480, 482 lases more powerfully may be at least partially determined by the respective unsaturated gain areas of the gain medium 410.

Because the laser modes 480, 482 have different wavelengths they shift in and out of phase with one another along the length of the optical cavity 440. At a second area 492 of the optical cavity 440, the laser modes 480, 482 are substantially out of phase. That is, a node of the first laser mode 480 occupies the same space as an antinode of the second laser mode 482 at the second area 492 of the optical cavity 440. At a third area 494 of the optical cavity 440, the laser modes 480, 482 are again substantially out of phase. However, at the third area 494 of the optical cavity 440 a node of the second laser mode 482 occupies the same space as an antinode of the first laser mode 480.

Laser modes with intermediate wavelengths (not shown) between the depicted laser modes 480, 482 will be able to extract power from the gain medium 410. Thus, the depicted laser modes 480, 482 and some intermediate laser modes will be able to lase successfully. However, the laser modes may not have the same power due to saturation of the gain medium 410 within the optical cavity 440. A periodicity of overlapping antinodes along the gain medium 410 may be thought of as being similar to a Moiré pattern. The average pattern of overlapping and non-overlapping antinodes along the gain medium 410 may produce groups of successful laser modes and less successful laser modes. That is, an integration across all areas along the gain medium 410 defines a coupling between laser modes, and at least partially determines which output frequencies are successful.

At a third area 496 of the optical cavity 440, antinodes of the laser modes 480, 482 are sufficiently spaced apart such that they may both lase. However, laser modes having intervening wavelengths (not shown) may not be able to extract sufficient power from the gain medium 410 to successfully lase because the available power is more efficiently extracted from the gain medium 410 by the laser modes 480, 482. As such, placing the gain medium 410 at the third area 496, adjacent to an end mirror, may contribute to the gain medium 410 generating two groups of successful, powerful laser modes 480, 482 that are separated by at least one group of less successful, less powerful laser modes. In general, mode competition may broaden a lasing spectrum of the gain medium. The action of mode competition and the nonlinear conversion provided by the nonlinear optical element 420 produces output electromagnetic radiation having a frequency spectrum comprising a first peak formed of a first group of successful frequencies, a second peak formed of a second group of successful frequencies, and a trough that separates the first and second peaks, the trough being associated with a less successful group of frequencies. The first and second peaks are the only dominant peaks in the frequency spectrum. This mode competition and nonlinear effects may alternatively or additionally cause the nonlinear optical element 420 to produce output electromagnetic radiation having a coherence curve comprising a contrast ratio of less than about 0.1 at an optical path difference that is within the inclusive range of about 1.5 mm to about 2.5 mm.

The position of the gain medium 410 in the optical cavity 440 at least partially determines the positions at which standing waves extract energy from the gain medium 410, and therefore at least partially determines which laser modes 480, 482 successfully lase. The position of the gain medium 410 within the optical cavity 440 may therefore be selected to at least partially determine a frequency spectrum of the output electromagnetic radiation 450 produced by the nonlinear optical element 420. For example, if the gain medium 410 is positioned adjacent one of the end mirrors 430, then laser modes which have very similar wavelengths will have overlapping antinodes such that there is lots of mode competition between these laser modes. The laser will preferentially oscillate at wavelengths which are sufficiently different to each other that both of the wavelengths can extract enough energy to lase, and thus the lasing spectrum is generally broadened. However, if the gain medium 410 is positioned too close to the end mirror 430, an etalon effect may occur which can alter the spectrum of the output electromagnetic radiation 450 making it more unstable. This unstable, noise-like behaviour is more likely to occur if the total number of laser modes is low, which may occur if the gain medium 410 is close to the end mirror 430. That is, if the gain medium 410 is positioned too close to the end mirror 430, the gain medium 410 and the end mirror 430 may together form an additional optical cavity that may modify the effective reflectivity of the end mirror 430. The additional optical cavity may have many high order laser modes and their resonances may not be stable in time. Introducing a misalignment between the gain medium 410 and the end mirror 430 (e.g. by tilting the gain medium 410) may reduce this etalon effect.

Competition between laser modes 480, 482 that results in one or more of the laser modes being unable to oscillate (thereby creating a gap in the spectrum of electromagnetic radiation produced by the nonlinear optical element 420) may be referred to as spatial hole burning. That is, a part of the spectrum of the output electromagnetic radiation 450 produced by the nonlinear optical element 420 that corresponds to a group of less successful laser modes is hindered through saturation of the gain medium 410 by other successful laser modes. A coherence property of the output electromagnetic radiation 450 produced by the nonlinear optical element 420 may be at least partially determined by using spatial hole burning to control which laser modes successfully lase and which laser modes less successfully lase.

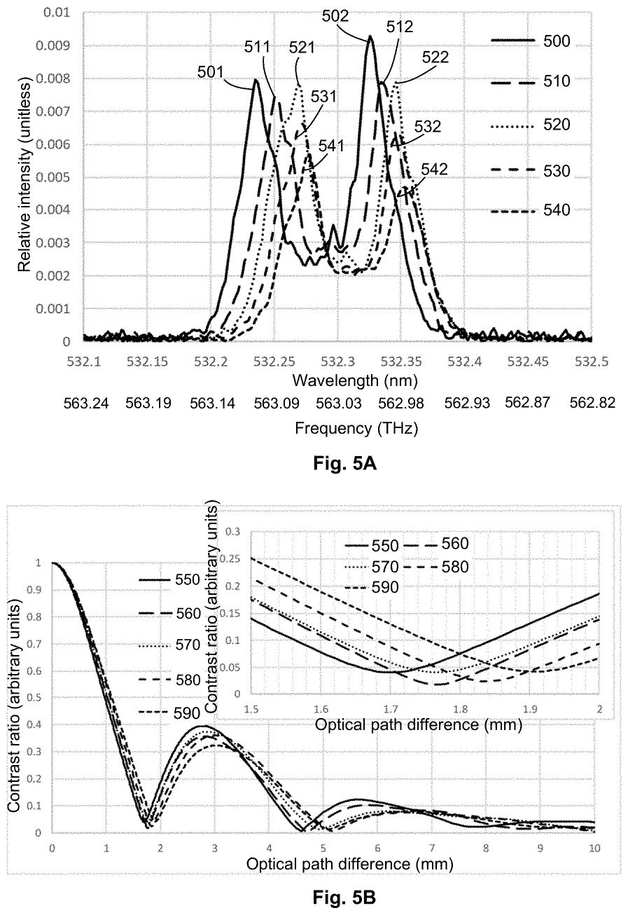

FIG. 5A shows an example of five different spectra 500-540 of output electromagnetic radiation produced by laser systems according to embodiments of the present disclosure. The laser systems may correspond to the laser system of FIG. 4A. The laser systems comprise a gain medium configured to amplify incident infrared electromagnetic radiation having a wavelength of about 1064 nm. The laser systems further comprise a nonlinear optical element (e.g. lithium triborate) configured to convert the infrared electromagnetic radiation amplified by the gain medium to a shorter wavelength of about 532 nm. The five spectra 500-540 correspond to the use of five different gain media. Each laser system associated with the spectra of FIG. 5A is configured to introduce mode competition and nonlinear effects such that the nonlinear optical element produces output electromagnetic radiation having a frequency spectrum comprising a first peak formed of a first group of frequencies, a second peak formed of a second group of frequencies, and a trough that separates the first and second peaks. The first and second peaks are the only dominant peaks in the frequency spectrum. Each laser system associated with the spectra of FIG. 5A is configured to introduce mode competition and nonlinear optical effects such that the nonlinear optical element produces output electromagnetic radiation having a coherence curve comprising a contrast ratio of less than about 0.1 at an optical path difference that is within the inclusive range of about 1.5 mm to about 2.5 mm.

A wavelength at maximum of a peak may correspond to an average wavelength of the peak. A first dominant peak 501 of the first spectrum 500 has a wavelength at maximum of about 532.23 nm. The first dominant peak 501 of the first spectrum 500 has a full width at half maximum (FWHM) of about 0.035 nm. A second dominant peak 502 of the first spectrum 500 has a wavelength at maximum of about 532.325 nm. The second dominant peak 502 of the first spectrum 500 has a FWHM of about 0.040 nm. A peak-to-peak spacing (i.e. a wavelength separation between maxima) of the first and second dominant peaks 501, 502 is about 0.10 nm. An intensity at the maximum of the first peak 501 of the first spectrum 500 is about 11% less than an intensity at the maximum of the second dominant peak 502 of the first spectrum 500. An average intensity across a trough that separates the first and second dominant peaks 501, 502 of the first spectrum 500 is about 30% of an average intensity at the maxima of the first and second dominant peaks 501, 502. Each trough may contain a local minimum located between the local maxima of the first and second dominant peaks. A wavelength at local minimum of the trough may correspond to an average wavelength across the trough. The wavelength of the trough may correspond to a wavelength of the spectrum at a centre position between the peaks (i.e. the midpoint of the peak-to-peak spacing).

A first dominant peak 511 of the second spectrum 510 has a wavelength at maximum of about 532.25 nm. The first dominant peak 511 of the second spectrum 510 has a FWHM of about 0.037 nm. A second dominant peak 512 of the second spectrum 510 has a wavelength at maximum of about 532.34 nm. The second dominant peak 502 of the second spectrum 510 has a FWHM of about 0.034 nm. A peak-to-peak spacing of the first and second dominant peaks 511, 512 is about 0.09 nm. An intensity at the maximum of the first peak 511 of the second spectrum 510 is about 4% less than an intensity at the maximum of the second dominant peak 512 of the second spectrum 510. An average intensity across a trough that separates the first and second dominant peaks 511, 512 of the second spectrum 510 is about 40% of an average intensity at the maxima of the first and second dominant peaks 511, 512.

A first dominant peak 521 of the third spectrum 520 has a wavelength at maximum of about 532.27 nm. The first dominant peak 521 of the third spectrum 520 has a FWHM of about 0.040 nm. A second dominant peak 522 of the third spectrum 520 has a wavelength at maximum of about 532.34 nm. The second dominant peak 522 of the third spectrum 520 has a FWHM of about 0.034 nm. A peak-to-peak spacing of the first and second dominant peaks 521, 522 is about 0.07 nm. An intensity at the maximum of the first peak 521 of the third spectrum 520 is substantially equal to an intensity at the maximum of the second dominant peak 522 of the third spectrum 520. An average intensity across a trough that separates the first and second dominant peaks 521, 522 of the third spectrum 520 is about 32% of an average intensity at the maxima of the first and second dominant peaks 521, 522. The first and second dominant peaks 521, 522 of the third spectrum 520 are generally symmetrical.

A first dominant peak 531 of the fourth spectrum 530 has a wavelength at maximum of about 532.27 nm. The first dominant peak 531 of the fourth spectrum 530 has a FWHM of about 0.040 nm. A second dominant peak 532 of the fourth spectrum 530 has a wavelength at maximum of about 532.35 nm. The second dominant peak 532 of the fourth spectrum 530 has a FWHM of about 0.037 nm. A peak-to-peak spacing of the first and second dominant peaks 531, 532 is about 0.08 nm. An intensity at the maximum of the first peak 531 of the fourth spectrum 530 is about 4% greater than an intensity at the maximum of the second dominant peak 532 of the fourth spectrum 530. An average intensity across a trough located between the first and second dominant peaks 531, 532 of the fourth spectrum 530 is about 34% of an average intensity at the maxima of the first and second dominant peaks 531, 532.

A first dominant peak 541 of the fifth spectrum 540 has a wavelength at maximum of about 532.28 nm. The first dominant peak 541 of the fifth spectrum 540 has a FWHM of about 0.037 nm. A second dominant peak 542 of the fifth spectrum 540 has a wavelength at maximum of about 532.36 nm. The second dominant peak 542 of the fifth spectrum 540 has a FWHM of about 0.042 nm. A peak-to-peak spacing of the first and second dominant peaks 541, 542 is about 0.08 nm. An intensity at the maximum of the first peak 541 of the fifth spectrum 540 is about 15% greater than an intensity at the maximum of the second dominant peak 542 of the fifth spectrum 540. An average intensity across a trough located between the first and second dominant peaks 541, 542 of the fifth spectrum 540 is about 42% of an average intensity at the maxima of the first and second dominant peaks 541, 542.

The peak-to-peak spacing of the first and second peaks of a frequency spectrum may correspond to a width of the trough that separates the peaks. A width of the trough may be greater than the FWHM of either peak (i.e. the trough may be wider than either of the peaks). Each peak may have an inverted V shape whereas the trough that separates the peaks may have a U shape.

FIG. 5B shows coherence curves 550-590 of the five different spectra 500-540 shown in FIG. 5A along with a magnified inset view of a portion of the coherence curves 550-590. A first coherence curve 550 corresponds to the first spectrum 500, a second coherence curve 560 corresponds to the second spectrum 510, a third coherence curve 570 corresponds to the third spectrum 520, a fourth coherence curve 580 corresponds to the fourth spectrum 530 and a fifth coherence curve 590 corresponds to the fifth spectrum 540. As can be seen, each spectrum 500-540 has its own characteristic coherence curve 550-590. As was the case with FIG. 3, all of the coherence curves 550-590 have a contrast ratio of one at an optical path difference of zero. However, unlike FIG. 3, each coherence curve 550-590 decreases to a first local minimum at an optical path difference of between about 1.70 mm and about 1.92 mm. That is, unlike FIG. 3, all of the laser systems associated with the spectra of FIGS. 5A, B produce output electromagnetic radiation having a contrast ratio of less than about 0.1 at an optical path difference of between about 1.5 mm and about 2.5 mm. Also unlike FIG. 3, all of the laser systems associated with the spectra of FIGS. 5A, B produce output electromagnetic radiation having a contrast ratio that reaches a first minimum at an optical path difference of less than about 2.5 mm, e.g. less than about 2.2 mm. The first minimum of the contrast ratio may be reached at an optical path difference of between about 1.5 mm and about 2.2 mm.

The laser systems that produced the spectra 500-540 of FIG. 5A are configured to introduce mode competition and nonlinear effects such that the nonlinear optical element produces output electromagnetic radiation having a frequency spectrum comprising a first peak formed of a first group of frequencies, a second peak formed of a second group of frequencies, and a trough that separates the first and second peaks. The first and second peaks are the only dominant peaks in each frequency spectrum. That is, the effects of mode competition (e.g. gain saturation, spatial hole burning, etc.) generally broadens the lasing spectrum of the gain medium, and the nonlinear effects (e.g. sum frequency generation, sum frequency mixing, etc.) introduced by the nonlinear optical element produce two groups of powerfully (i.e. successfully) lasing output frequencies whilst another group of intervening output frequencies lases less powerfully (i.e. less successfully). There are multiple ways in which mode competition and/or nonlinear effects can be introduced to a laser system to produce output electromagnetic radiation having a spectrum comprising two dominant peaks separated by a trough and/or having a desired coherence property.

Referring again to FIG. 4A, the gain medium 410 may be positioned between the first end mirror 430 and a centre of the optical cavity 440 such that a gap 442 between the gain medium 410 and the first end mirror 430 is smaller than a gap between the gain medium 410 and the centre of the optical cavity 440. The centre of the optical cavity 440 may correspond to a location along the optical path of the electromagnetic radiation 415 that is equidistant from the first and second end mirrors 430, 432. In the example of FIG. 4A, the centre of the optical cavity 440 is proximate the wavelength selective reflector 435. Positioning the gain medium 410 in this way introduces and balances mode competition between different groups of laser modes and thereby encourages the production of output electromagnetic radiation 450 having a spectrum comprising first and second dominant peaks separated by a trough. The gap 442 between the gain medium 410 and the first end mirror 430 may be about 0.8 mm or more. The gap 442 between the gain medium 410 and the first end mirror 430 may be about 1.4 mm or less. The laser system 400 may comprise an actuator 460 configured to adjust the position of the gain medium 410 within the optical cavity 440. For example, the actuator 460 may be configured to change the gap 442 between the gain medium 410 and the first end mirror 430. The actuator 460 may be configured to adjust the position of the gain medium 410 within the optical cavity 440 by about 0.1 mm or more. The actuator 460 may be configured to adjust the position of the gain medium 410 within the optical cavity 440 by about 1 mm or less. The actuator 460 may, for example comprise a mount supported on a longitudinally arranged screw-thread such that rotation of the screw thread moves the mount. Alternatively, the actuator 460 may be absent and the gain medium 410 may be fixed at a desired location within the optical cavity.

The laser system 400 may comprise a controller 470 configured to control an operating parameter of the gain medium 410 and/or the nonlinear optical element 420 to at least partially determine a form of the first and second dominant peaks present in the spectrum of the output electromagnetic radiation 450. The form of the first and second peaks may comprise, for example, wavelength at maximum, FWHM, peak-to-peak spacing, intensity at maximum, average intensity across a trough located between the peaks, a shape of the peaks and/or the trough, etc. For example, the laser system 400 may comprise an optical pump source 472 configured to provide pump electromagnetic radiation 474 to the gain medium 410. The controller 470 may be configured to control the optical pump source 472. An operating parameter that is controlled by the controller 470 may comprise a power of the pump electromagnetic radiation 474. The power of the pump electromagnetic radiation 474 may at least partially determine a width of the spectrum of the output electromagnetic radiation 450. For example, the controller 470 may be configured to increase the power of the pump electromagnetic radiation 474 to broaden the spectrum of the output electromagnetic radiation 450. Increasing the power of the pump electromagnetic radiation 474 may increase a temperature of the gain medium 410 which in turn may broaden the spectrum of the output electromagnetic radiation 450. At higher laser powers, a beam dump (not shown) may be provided to remove part of output electromagnetic radiation (e.g. to reduce a power of the output electromagnetic radiation 450 by a factor of about 10-15, e.g. 12).

The gain medium 410 may be configured to absorb a range of pump powers. The range of pump powers absorbed by the gain medium 410 may be at least partially determined by a selection of one or more of a doping concentration, a pump wavelength, a gain medium material and/or a gain medium length along the optical axis. The gain medium 410 may be configured to absorb about 2 W or more of pump power. The gain medium 410 may be configured to absorb about 7 W or less of pump power.

The laser system 400 may comprise a heating system 465 configured to adjust a temperature of the gain medium 410. The controller 470 may be configured to control the heating system 465. An operating parameter controlled by the controller 470 may comprise the temperature of the gain medium 410. The temperature of the gain medium 410 may at least partially determine a width of the spectrum of the output electromagnetic radiation 450, e.g. through homogeneous broadening. The temperature of the gain medium 410 may at least partially determine a peak-to-peak spacing between the first and second dominant peaks of the spectrum of the output electromagnetic radiation 450. For example, the controller 470 may be configured to increase the temperature of the gain medium 410 to broaden the spectrum of the output electromagnetic radiation 450. The controller 470 may be configured to set the temperature of the gain medium 410 to about 40° C. or more. The controller may be configured to set the temperature of the gain medium 410 to about 80° C. or less. For example, the controller 470 may be configured to set the temperature of the gain medium 610 to about 60° C. The temperature of the gain medium 410 may at least partially determine a width of the spectrum of the output electromagnetic radiation 450 through homogenous broadening.

The laser system 400 may comprise a heater 465 configured to adjust a temperature of the nonlinear optical element 420. In the example of FIG. 4A, the heater 465 and the heating system 465 are the same device. Separate heating devices may be used to heat the gain medium 410 and the nonlinear optical element 420. The controller 470 may be configured to control the heater 465. An operating parameter that is controlled by the controller 470 may comprise the temperature of the nonlinear optical element 420. The temperature of the nonlinear optical element 420 may at least partially determine a peak-to-peak spacing of the first and second dominant peaks of the spectrum of the output electromagnetic radiation 450. For example, the controller 470 may be configured to increase the temperature of the nonlinear optical element 420 to increase the peak-to-peak spacing between the first and second dominant peaks of the spectrum of the output electromagnetic radiation 450. The controller 470 may be configured to set the temperature of the nonlinear optical element 420 to a phase matching temperature such that a conversion efficiency of the nonlinear optical element 420 is increased. The phase matching temperature may correspond to the temperature at which a refractive index of the nonlinear optical element 420 is substantially the same for both infrared radiation and frequency doubled radiation. The phase matching temperature may be about 45° C. or more. The phase matching temperature may be about 55° C. or less. The controller 470 may be configured to adjust the temperature of the nonlinear optical element 420 to about +1-1° C. of the phase matching temperature to contribute to the production of the first and second dominant peaks.

An aperture may be provided next to the nonlinear optical element 420 for selecting a mode. For example, the aperture may be configured to ensure that a fundamental TEM00 transverse mode lases within the laser system.

The laser system 400 may comprise a spectrometer 468 configured to measure a value that is indicative of a coherence property of the output electromagnetic radiation 450. The spectrometer 468 may comprise an interferometer (such as the Fourier-transform interferometer 220 of FIG. 2A). In the example of FIG. 4A, a second beam splitter 437 is configured to split the output electromagnetic radiation 450 such that a portion of the output electromagnetic radiation 452 is provided to the spectrometer 468 for analysis. The controller 470 may be configured to control the operating parameter such that the value that is indicative of a coherence property of the output electromagnetic radiation 450 is in a predetermined range. The value that is indicative of a coherence property of the output electromagnetic radiation 450 may at least partially depend on a contrast ratio of the output electromagnetic radiation 450 and an optical path difference of the spectrometer 468. For example, the value that is indicative of a coherence property of the output electromagnetic radiation 450 may form part of a coherence curve of the output electromagnetic radiation 450 (e.g. the coherence curves 550-590 shown in FIG. 5B). The controller 470 may be configured to control the operating parameter(s) such that the coherence curve of the output electromagnetic radiation 450 satisfies a predetermined requirement. The controller 470 may be configured to control the operating parameter(s) such that a contrast ratio of the output electromagnetic radiation 450 is less than a predetermined value when the optical path difference of the spectrometer 468 is within a predetermined range. For example, the controller 470 may be configured to control the operating parameter such that the laser system 400 produces output electromagnetic radiation 450 having a contrast ratio of less than about 0.1 for an optical path difference of between about 1.5 mm and about 2.5 mm (e.g. such as the coherence curves 550-590 shown in FIG. 5B). As another example, the controller 470 may be configured to control the operating parameter such that the laser system 400 produces output electromagnetic radiation having a contrast ratio of less than about 0.1 for an optical path difference of between about 1.6 mm and about 2.0 mm (e.g. such as at least some of the coherence curves 550-590 shown in FIG. 5B).

An angle, such as an out-of-phase-matching-plane angle (e.g. a vertical angle), between an optical axis 422 of the nonlinear optical element 420 and a propagation axis of electromagnetic radiation 415 incident on the nonlinear optical element 420 may be configured to at least partially determine a form of the first and second dominant peaks present in the spectrum of the output electromagnetic radiation 450. The angle between the optical axis 422 of the nonlinear optical element 420 and the propagation axis of the electromagnetic radiation 415 may correspond to an out-of-phase-matching angle of the nonlinear optical element 420. To clarify the drawing, a Cartesian coordinate system is shown in FIG. 4A. The Cartesian coordinate system has three axis, i.e., an x-axis, a y-axis and a z-axis (not shown). Each of the three axis is orthogonal to the other two axis. The Cartesian coordinate system is not limiting and is used for clarification only. The nonlinear optical element 420 may be rotated about the y-axis and/or the z-axis to introduce the angle between the optical axis 422 of the nonlinear optical element 420 and the propagation axis of the electromagnetic radiation 415. That is, the nonlinear optical element 420 may be rotated out of a plane of the incident electromagnetic radiation 415. Rotation of the nonlinear optical element 420 about the y-axis may be referred to as a vertical rotation with respect to the incident electromagnetic radiation 415. The vertical rotation of the nonlinear optical element 420 may correspond to adjusting an angle that is perpendicular to a phase-matching angle of the nonlinear optical element 420. Rotation of the nonlinear optical element 420 about the z-axis may be referred to as a horizontal rotation with respect to the incident electromagnetic radiation 415. The horizontal rotation of the nonlinear optical element 420 may correspond to adjusting the phase-matching angle of the nonlinear optical element 420. The out-of-phase-matching-plane angle between the optical axis 422 of the nonlinear optical element 420 and a propagation axis of the electromagnetic radiation 415 may be about 4° or more. The laser system 400 may comprise an actuation system 460 configured to adjust the angle between the optical axis 422 of the nonlinear optical element 420 and the propagation axis of the electromagnetic radiation 415. In the example of FIG. 4A, the actuator 460 and the actuation system 460 are the same device. Separate actuation devices may be used to move the gain medium 410 and move the nonlinear optical element 420.

At least one of the first and second end mirrors 430, 432 may comprise a concave reflective surface configured to reflect the electromagnetic radiation 415 amplified by the gain medium 410. In the example of FIG. 4A, the first end mirror 430 comprises a concave reflective surface and the second end mirror 432 comprises a flat reflective surface. Both end mirrors 430, 432 may comprise a concave reflective surface. The concave reflective surface may focus reflected electromagnetic radiation and thereby assist in maintaining a stability of the laser cavity.

The material of the gain medium 410 may be selected to contribute to the formation of the first and second dominant peaks in the spectrum of the output electromagnetic radiation 450. For example, the gain medium 410 may comprise a crystal having an Nd dopant, e.g. Nd:YVO4, Nd:GdVO4, Nd:YAG, Nd:YAP, Nd:YLF, Nd:KGW, etc. A bandwidth of the electromagnetic radiation amplified by the gain medium 410 may at least partially depend upon the material of the gain medium 410. For example, using Nd:GdVO4 as a gain medium may increase the bandwidth of the spectrum of electromagnetic radiation 415 amplified by the gain medium 410 compared to other crystals such as, for example Nd:YAG.

The shape of the gain medium 410 may be selected to contribute to the formation of the first and second dominant peaks in the spectrum of the output electromagnetic radiation 450. For example, the gain medium may have a parallelepiped shape.

A length of the gain medium 410 may be selected to contribute to the formation of the first and second dominant peaks in the spectrum of the output electromagnetic radiation 450. The gain medium 410 may be elongate along its optical axis. That is, as shown in FIG. 4A, a greatest distance between two ends of the gain medium 410 may exist along its optical axis. In other words, a length (i.e. the greatest of three dimensions) of the gain medium 410 exists along its optical axis. For example, the gain medium 410 may have a length along its optical axis of about 4 mm or more. The gain medium 410 may have a length along its optical axis of about 7 mm or less.

A dopant of the gain medium 410 may be selected to contribute to the formation of the first and second dominant peaks in the spectrum of the output electromagnetic radiation 450. For example, the gain medium 410 may comprise a dopant that is typically used in solid state lasers such as, for example, Yb, Pr, Er, etc. A doping concentration of the gain medium 410 may be selected to contribute to the formation of the first and second dominant peaks in the spectrum of the output electromagnetic radiation 450. For example, the gain medium 410 may comprise a doping concentration of about 0.3% or more. The gain medium may comprise a doping concentration of about 0.7% or less.

Characteristics and/or operating parameters of the laser system 400 described above in relation to FIG. 4A may be combined in different ways to introduce mode competition and nonlinear effects such that the nonlinear optical element produces output electromagnetic radiation having a frequency spectrum comprising first and second dominant peaks separated by a trough. For example, characteristics and/or operating parameters of the laser system 400 may be controlled in order to control the gain saturation, spatial hole burning and/or nonlinear optical effects in the laser system 400.

For example, the controller 470 may increase the power of the pumping electromagnetic radiation 474 and/or the temperature of the gain medium 410 to broaden the spectrum of the electromagnetic radiation 415 emitted by the gain medium 410 (i.e., reduce a coherence length of the electromagnetic radiation 415 for a given optical path difference). The angle between the optical axis 422 of the nonlinear optical element 420 and the propagation axis of the electromagnetic radiation 415 may be fixed, or adjusted by the actuator 460, to balance mode competition and nonlinear effects to form the first and second dominant peaks in the spectrum of the output electromagnetic radiation 450.

Different characteristics and/or operating parameters of the laser system 400 may be influenced by each other. That is, the laser system 400 may be considered a multi-variable system, and the effect of different variables on the spectrum of the output electromagnetic radiation 450 may be coupled with each other in different ways. For example, a temperature of the nonlinear optical element 420 may be coupled with the angle between the optical axis 422 of the nonlinear optical element 420 and the propagation axis of the electromagnetic radiation 415 (e.g. an out-of-phase-matching angle of the nonlinear optical element 420). The nonlinear optical element 420 may be located close to the second end mirror 432. The nonlinear optical element 420 may be located about 2 mm or more from the second end mirror 432. The nonlinear optical element 420 may be located about 5 mm or less from the second end mirror 432. The out-of-phase-matching angle of the nonlinear optical element 420 may be selected at least in part to reduce or avoid an etalon effect that may otherwise alter the spectrum of the output electromagnetic radiation 450.

A change of the phase-matching angle of the nonlinear optical element 420 to control a coherence curve of the output electromagnetic radiation 450 may be coupled with a change to the temperature of the nonlinear optical element 420 to maintain a desired phase-matching effect. Alternatively, a change to the temperature of the nonlinear optical element 420 to control a coherence curve of the output electromagnetic radiation 450 may be coupled with a change to the phase-matching angle of the nonlinear optical element 420 to maintain a desired phase-matching effect. For example, the first and second dominant peaks in the spectrum of the output electromagnetic radiation 450 may be achieved across a nonlinear optical element 420 temperature range of about 2° C. whilst the phase-matching angle of the nonlinear optical element 420 is adjusted across a range of about 1.5 mrad to maintain a desired phase-matching effect. Adjusting the angle that is perpendicular to a phase-matching angle of the nonlinear optical element 420 (i.e. a vertical rotation of the nonlinear optical element 420) to between about 4° and about 4.5° may reduce or avoid the etalon effect for any phase-matching angle position of the nonlinear optical element 420. The two dominant peaks in the spectrum of the output electromagnetic radiation 450 may then be achievable across a greater range of temperatures (e.g. a range of about 8° C.) of the nonlinear optical element 420. The temperature of the nonlinear optical element 420 may be set to about 35° C. or more. The temperature of the nonlinear optical element 420 may be set to about 55° C. or less.

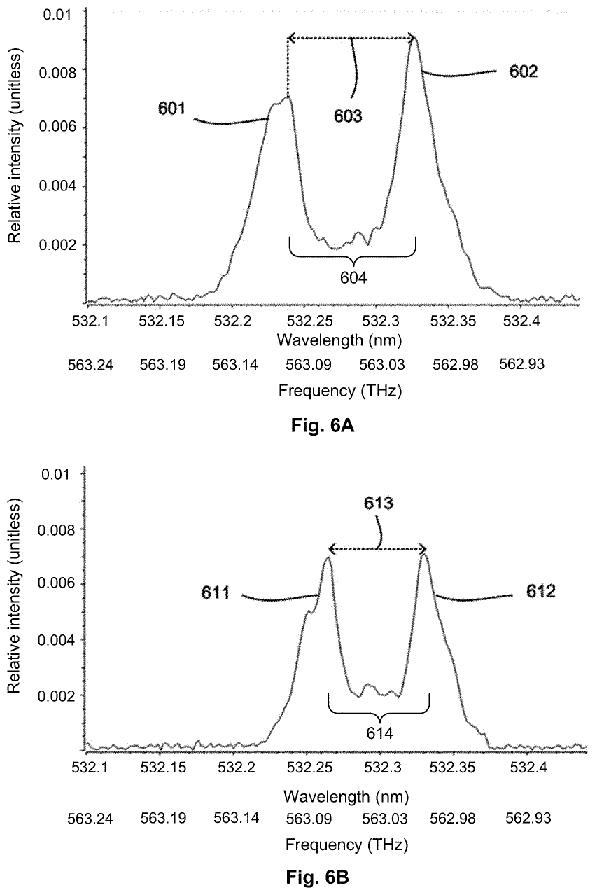

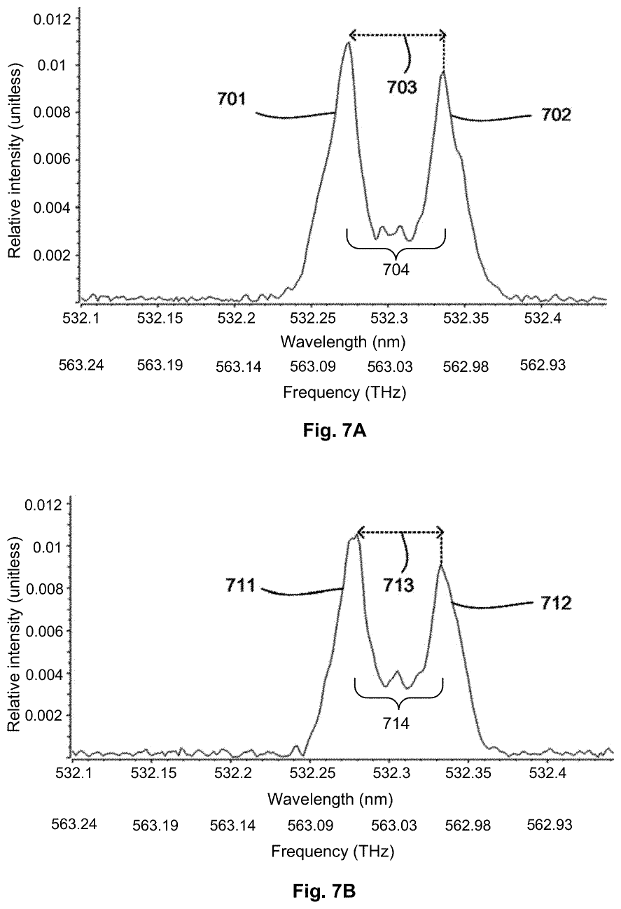

FIGS. 6A-7B show examples of how a form of the first and second dominant peaks of the output electromagnetic radiation 450 is altered when a gap 442 between the gain medium 410 and the first end mirror 430 is changed. The spectra of FIGS. 6A-7B were produced by a laser system comprising a gain crystal comprising Nd:YVO4 and a nonlinear optical element comprising lithium triborate. As previously discussed, changing the gap 442 between the gain medium 410 and the first end mirror 430 changes the mode competition between the laser modes in the laser system 400. As previously discussed in relation to FIGS. 4A and 4B, increasing the gap 442 between the gain medium 410 and the first end mirror 430 moves the gain medium 410 away from the first area 490 at which antinodes of the laser modes 480, 482 are superimposed and towards other areas 492, 494 where antinodes of the laser modes 480, 482 are less superimposed. This reduces mode competition between the laser modes 480 482 and thereby may increase the number of laser modes that are able to lase in the gain medium 410. This may, in turn, reduce a peak-to-peak spacing of the first and second dominant peaks of the spectrum of the output electromagnetic radiation 450.

In the example of FIG. 6A, the gap 442 between the gain medium 410 and the first end mirror 430 is about 1.1 mm and the peak-to-peak spacing 603 between the first and second dominant peaks 601, 602 is about 0.093 nm. In the example of FIG. 6B, the gap 442 between the gain medium 410 and the first end mirror 430 is about 1.7 mm and the peak-to-peak spacing 613 between the two dominant peaks 611, 612 is about 0.067 nm. That is, a width of the trough 604, 614 that separates the first and second peaks 601, 602, 611, 612 decreases between FIG. 6A and FIG. 6B. Other changes to the form of the first and second peaks 601, 602, 611, 612 occurs between FIG. 6A and FIG. 6B. For example, a difference in the maximum intensity of the first and second peaks 601, 602, 611, 612 decreases between FIG. 6A and FIG. 6B. As another example, a wavelength at maximum of the first peak 601, 611 increases between FIG. 6A and FIG. 6B. In the example of FIG. 7A, the gap 442 between the gain medium 410 and the first end mirror 430 is about 2.1 mm and the peak-to-peak spacing 703 between the two dominant peaks 701, 702 is about 0.062 nm. In the example of FIG. 7B, the gap 442 between the gain medium 410 and the first end mirror 430 is about 2.6 mm and the peak-to-peak spacing 713 between the two dominant peaks 711, 712 is about 0.058 nm. That is, a width of the trough 704, 714 that separates the first and second peaks 701, 702, 711, 712 decreases between FIG. 7A and FIG. 7B. Other changes to the form of the first and second peaks 701, 702, 711, 712 occurs between FIG. 7A and FIG. 7B. For example, a local minimum (i.e. an average intensity) of the trough 704, 714 increases between FIG. 7A and FIG. 7B.

In the examples of FIGS. 6A-7B, increasing the gap 442 between the gain medium 410 and the first end mirror 430 decreases a peak-to-peak spacing between the first and second dominant peaks of the output electromagnetic radiation 450. That is, increasing the gap 442 between the gain medium 410 and the first end mirror 430 decreases a width of the trough that separates the first and second peaks of the spectrum the output electromagnetic radiation 450. Thus, controlling the gap 442 between the gain medium 410 and the first end mirror 430 allows control of the frequency spectrum and the coherence curve of the output electromagnetic radiation 450. For example, setting the gap 442 between the gain medium 410 and the first end mirror 430 to within the inclusive range of about 0.8 mm and about 1.4 mm may compress the coherence curve of the output electromagnetic radiation 450 such that the first local minimum of the coherence curve has a contrast ratio of about 0.1 or less at an optical path difference that is within the inclusive range of about 1.5 mm to about 2.5 mm.

As discussed above, the laser system 400 is a multi-variable system, and so other characteristics and/or operating parameters (such as a temperature of the gain medium 410) may be controlled to control the frequency spectrum and/or the coherence curve of the output electromagnetic radiation 450. For example, increasing the temperature of the gain medium 410 may increase a bandwidth of the electromagnetic radiation 415 amplified by the gain medium 410, which in turn may allow more laser modes to successfully lase within the laser system 400. Having a greater number of laser modes lasing in the laser system 400 may provide a greater number of options in selecting the first and second peaks in the frequency spectrum of the output electromagnetic radiation 450. For example, setting the temperature of the gain medium 410 to about 60° C. has been found to provide desirable effects in the formation of the first and second dominant peaks.

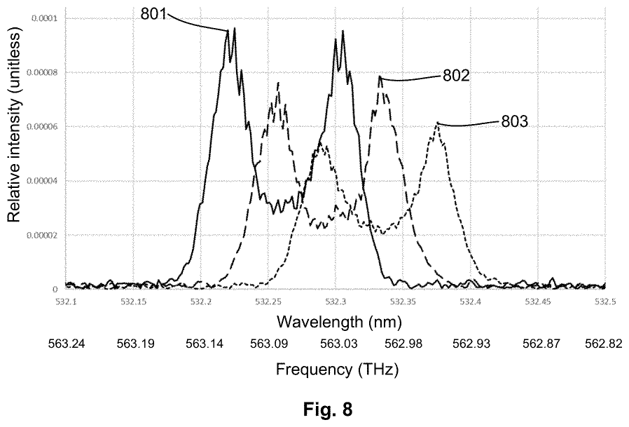

FIG. 8 shows three spectra 801-803 produced by a laser system comprising a gain medium set at three different temperatures. A first spectrum 801 corresponds to a first gain medium temperature, a second spectrum 802 corresponds to a second gain medium temperature and a third spectrum 803 corresponds to a third gain medium temperature. The first temperature is 20° C. less than the second temperature and the second temperature is 20° C. less than the third temperature. As can be seen, increasing the temperature of the gain medium increases a peak-to-peak spacing between the dominant peaks of the spectra 801-803. Increasing the temperature of the gain medium also shifts the two dominant peaks of the spectra 801-803 to longer wavelengths. That is, a wavelength at maximum of the first peak of the first spectrum 801 is less than a wavelength at maximum of the first peak of the second spectrum 802, and the wavelength at maximum of the first peak of the second spectrum 802 is less than a wavelength at maximum of the first peak of the third spectrum 803. Increasing the temperature of the gain medium also increases a FWHM of the dominant peaks of the spectra 801, 803. Increasing the temperature of the gain medium also reduces the maximum intensities of the first and second peaks whilst having a relatively small impact on an average intensity of the trough that separates the first and second peaks. That is, increasing the temperature of the gain medium reduces a difference between intensities of the maxima of the first and second peaks and the average intensity of the trough that separates the first and second peaks. At some optical path differences, the temperature of the gain medium may have a negligible effect on a contrast ratio of the output electromagnetic radiation.

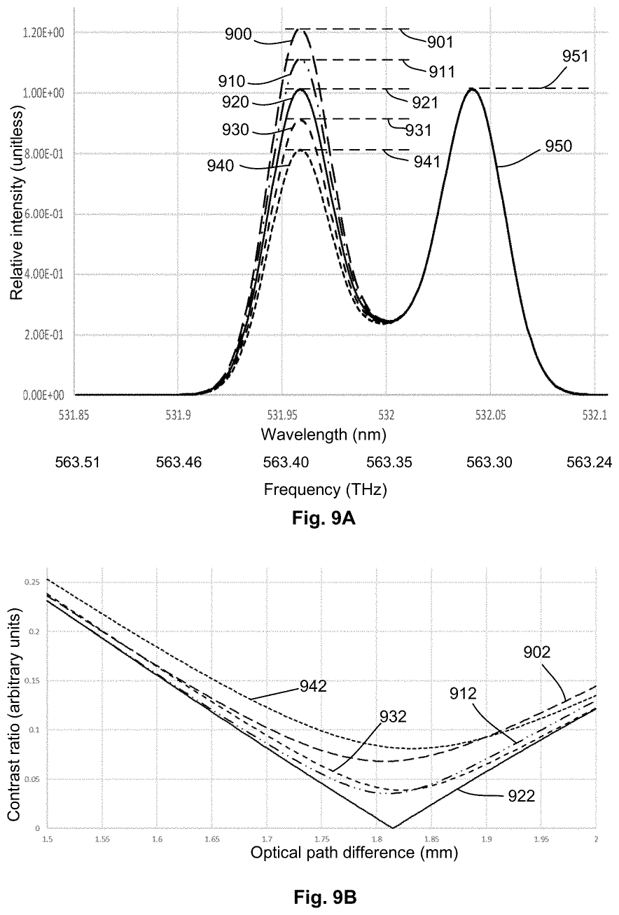

FIGS. 9A-11B show example simulations of how changes to the form of the first and second dominant peaks of the spectrum of the output electromagnetic radiation alter a coherence curve of the output electromagnetic radiation. FIG. 9A shows five different spectra 900-940, wherein each spectrum comprises a first dominant peak having a different peak height 901-941 (and different FWHM) compared to the other spectra. A first spectrum 900 comprises a highest first peak 901 (i.e. the largest maximum intensity). A second spectrum 910 comprises a second highest first peak 911 (i.e. the second largest maximum intensity). A third spectrum 920 comprises a third highest first peak 921 (i.e. the third largest maximum intensity). A fourth spectrum 930 comprises a fourth highest first peak 931 (i.e. the fourth largest maximum intensity). A fifth spectrum 940 comprises a fifth highest first peak 941 (i.e. the smallest maximum intensity). The first and second spectra 900, 910 include first peak heights 901, 911 that are higher than a height 951 of the second peak 950. That is, the first and second spectra 900, 910 include first peaks having greater maximum intensities 901, 911 than the intensity 951 of the second peak 950. The third spectrum 920 includes a first peak height 921 that is equal to the height 951 of the second peak 950. That is, the third spectrum 920 includes a first peak maximum intensity 921 that is equal to the second peak maximum intensity 951. The fourth and fifth spectra 930, 940 include first peak heights 931, 941 that are less than the height 951 of the second peak 950. An intensity at the maximum of the first peak of each spectrum is within about 20% of an intensity at the maximum of the second peak of each spectrum. The first spectrum 900 includes an intensity at the maximum of the first peak 901 that is about 20% greater than an intensity at the maximum of the second peak 951. The fifth spectrum 940 includes an intensity at the maximum of the first peak 941 that is about 20% less than an intensity at the maximum of the second peak 951. Despite these differences in the forms of the peaks, each spectrum 900-940 comprises a first peak formed of a first group of successful frequencies, a second peak formed of a second group of successful frequencies, and a trough that separates the first and second peaks. The first and second peaks of each spectrum 900-940 are the only dominant peaks in each frequency spectrum.

FIG. 9B shows simulations of the coherence curves 902-942 of the five spectra 900-940 shown in FIG. 9A. A first coherence curve 902 corresponds with the first spectrum 900. A second coherence curve 912 corresponds with the second spectrum 910. A third coherence curve 922 corresponds with the third spectrum 920. A fourth coherence curve 932 corresponds with the fourth spectrum 930. A fifth coherence curve 942 corresponds with the fifth spectrum 940. Again, although the forms of the peaks vary, each coherence curve comprises a contrast ratio of less than about 0.1 at an optical path difference that is within the inclusive range of about 1.5 mm to about 2.5 mm. In the example of FIG. 9B, the coherence curves have a contrast ratio of less than 0.1 between optical path differences of about 1.655 mm and about 1.953 mm.

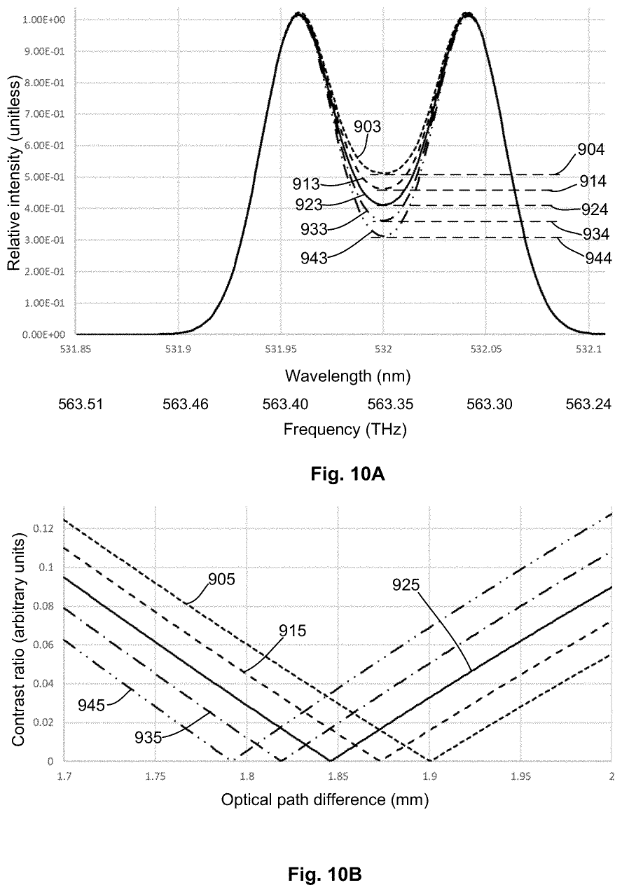

FIG. 10A shows simulations of five different spectra 903-943, wherein each spectra comprises a different trough local minimum 904-944 between the first and second dominant peaks of the spectrum. A first spectrum 903 comprises a shallowest trough 904 (i.e. a highest intensity local minimum). A second spectrum 913 comprises a second shallowest trough 914 (i.e. a second highest intensity local minimum). A third spectrum 923 comprises a third shallowest trough 924 (i.e. a third highest intensity local minimum). A fourth spectrum 933 comprises a fourth shallowest trough 934 (i.e. a fourth highest intensity local minimum). A fifth spectrum 943 comprises a fifth shallowest trough 944 (i.e. the lowest intensity local minimum). The local minimum intensities of the troughs of each spectra 903-943 vary between about 20% and about 0%. An average intensity across each trough is between about 50% less and about 70% less than an average intensity at the maxima of the first and second dominant peaks. Despite these differences in the forms of the peaks, each spectrum 900-940 comprises a first peak formed of a first group of successful frequencies, a second peak formed of a second group of successful frequencies, and a trough that separates the first and second peaks. The first and second peaks of each spectrum 900-940 are the only dominant peaks in each frequency spectrum.

FIG. 10B shows simulations of the coherence curves 905-945 of the five spectra 903-943 shown in FIG. 10A. A first coherence curve 905 corresponds with the first spectrum 903. A second coherence curve 915 corresponds with the second spectrum 913. A third coherence curve 925 corresponds with the third spectrum 923. A fourth coherence curve 935 corresponds with the fourth spectrum 933. A fifth coherence curve 945 corresponds with the fifth spectrum 943. As can be seen, increasing a depth of the trough 904-944 between the two dominant peaks of the spectrum 903-943 decreases the optical path difference at which the coherence curves 905-945 reach their first minimum. That is, increasing a depth of the trough 904-944 between the two dominant peaks of the spectrum 903-943 compresses the coherence curve 905-945 associated with the spectrum 903-943. Again, although the forms of the peaks vary, each coherence curve 905-945 comprises a contrast ratio of less than about 0.1 at an optical path difference that is within the inclusive range of about 1.5 mm to about 2.5 mm. In the example of FIG. 10B, the coherence curves have a contrast ratio of less than 0.1 between optical path differences of about 1.7 mm and about 2.0 mm.

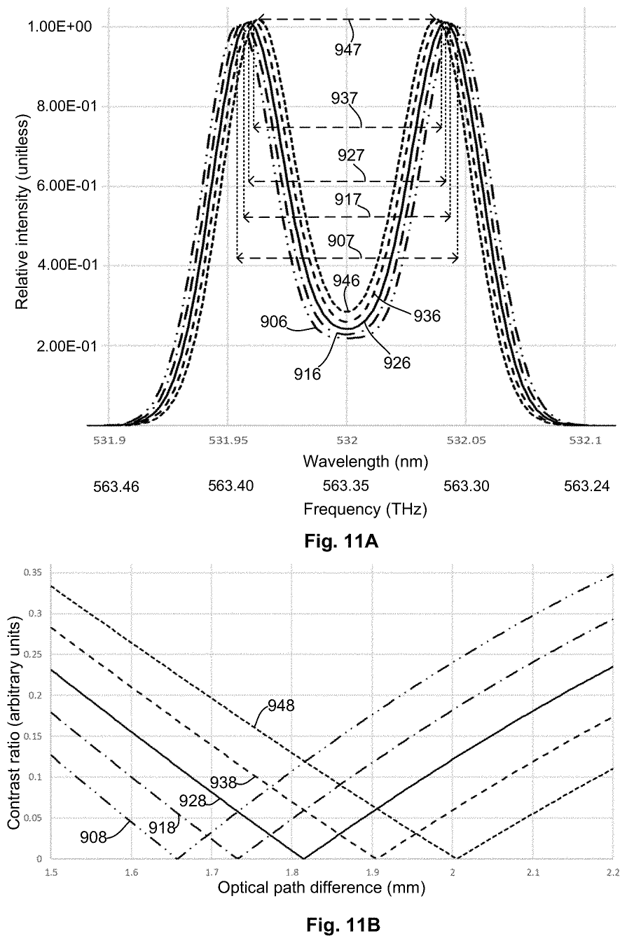

FIG. 11A shows simulations of five different spectra 906-946, wherein each spectra comprises a different peak-to-peak spacing 907-947 between the first and second dominant peaks of the spectrum. A first spectrum 906 comprises a largest peak-to-peak spacing 907. A second spectrum 916 comprises a second largest peak-to-peak spacing 917. A third spectrum 926 comprises a third largest peak-to-peak spacing 927. A fourth spectrum 936 comprises a fourth largest peak-to-peak spacing 937. A fifth spectrum 946 comprises a fifth largest peak-to-peak spacing 947. The peak-to-peak spacings 907-947 vary from about 0.10 nm to about 0.06 nm. In general, increasing a peak-to-peak spacing of the first and second peaks may reduce a local minimum intensity of the trough that separates the first and second peaks. Despite these differences in the forms of the peaks, each spectrum 906-946 comprises a first peak formed of a first group of successful frequencies, a second peak formed of a second group of successful frequencies, and a trough that separates the first and second peaks. The first and second peaks of each spectrum 906-946 are the only dominant peaks in each frequency spectrum.

FIG. 11B shows simulations of the coherence curves 908-948 of the five spectra 906-946 shown in FIG. 11A. A first coherence curve 908 corresponds with the first spectrum 906. A second coherence curve 918 corresponds with the second spectrum 916. A third coherence curve 928 corresponds with the third spectrum 926. A fourth coherence curve 938 corresponds with the fourth spectrum 936. A fifth coherence curve 948 corresponds with the fifth spectrum 946. As can be seen, increasing a peak-to-peak spacing 907-947 between the first and second dominant peaks of the spectrum 906-946 decreases the optical path difference at which the coherence curves 908-948 reach their first minimum. That is, increasing a peak-to-peak spacing 907-947 between the first and second dominant peaks of the spectrum 906-946 compresses the coherence curve 908-948 associated with the spectrum 906-946. Again, although the forms of the peaks vary, each coherence curve 908-948 comprises a contrast ratio of less than about 0.1 at an optical path difference that is within the inclusive range of about 1.5 mm to about 2.5 mm. In the example of FIG. 11B, the coherence curves 908-948 have a contrast ratio of less than 0.1 between optical path differences of about 1.53 mm and about 2.18 mm.

As shown in FIGS. 5A-11A, a lowest intensity of the spectra at the trough is non-zero. That is, the frequency spectra do not reach an intensity of zero between the first and second peaks. Groups of frequencies associated with the troughs that are relatively unsuccessful in terms of mode competition still contribute to the intensity of the output electromagnetic radiation.

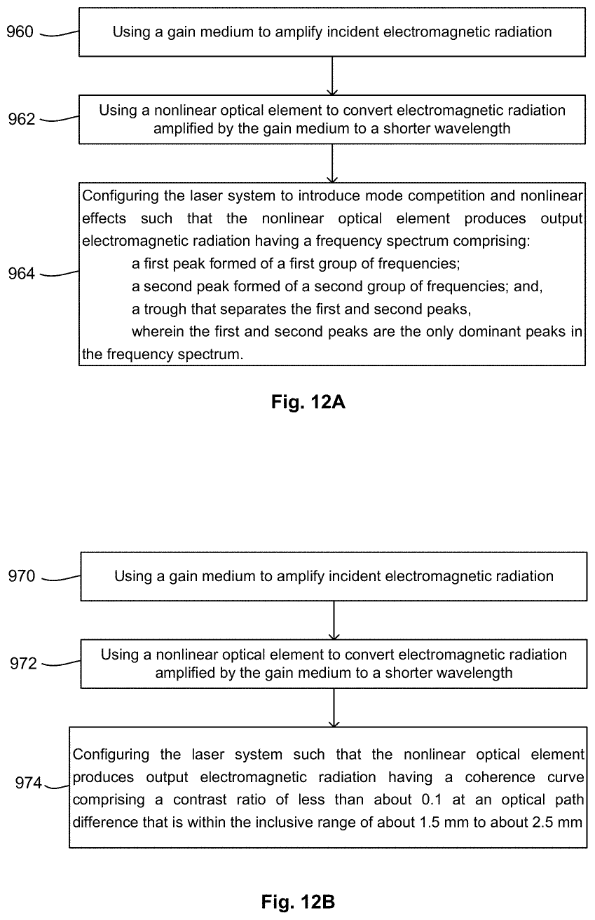

FIG. 12A shows a flowchart of a method of operating a laser system according to an embodiment of the present disclosure. The laser system may, for example, be the laser system shown in FIG. 4A. With reference to FIG. 4A, a first step 960 of the method comprises using a gain medium 410 to amplify incident electromagnetic radiation 415. A second step 962 of the method comprises using a nonlinear optical element 420 to convert electromagnetic radiation 415 amplified by the gain medium 410 to a shorter wavelength. A third step 964 of the method comprises configuring the laser system 400 to introduce mode competition and nonlinear effects such that the nonlinear optical element 420 produces output electromagnetic radiation having a frequency spectrum comprising a first peak formed of a first group of frequencies, a second peak formed of a second group of frequencies, and a trough that separates the first and second peaks, wherein the first and second peaks are the only dominant peaks in the frequency spectrum (such as the spectra shown in FIGS. 5A, 6A-B, 7A-B, 8, 9A, 10A and 11A).

FIG. 12B shows a flowchart of another method of operating a laser system according to an embodiment of the present disclosure. The laser system may, for example, be the laser system shown in FIG. 4A. With reference to FIG. 4A, a first step 970 of the method comprises using a gain medium 410 to amplify incident electromagnetic radiation 415. A second step 972 of the method comprises using a nonlinear optical element 420 to convert electromagnetic radiation 415 amplified by the gain medium 410 to a shorter wavelength. A third step 974 of the method comprises configuring the laser system such that the nonlinear optical element 420 produces output electromagnetic radiation having a coherence curve comprising a contrast ratio of less than about 0.1 at an optical path difference that is within the inclusive range of about 1.5 mm to about 2.5 mm (such as the coherence curves shown in FIGS. 5B, 9B, 10B and 11B).

Either of the methods of FIG. 12A and FIG. 12B may further comprise arranging first and second end mirrors to form an optical cavity containing the gain medium and the nonlinear optical element and positioning the gain medium 410 between the first end mirror 430 and a centre of the optical cavity 440 such that a gap 442 between the gain medium 410 and the first end mirror 430 is smaller than a gap between the gain medium 410 and the centre of the optical cavity 440. Either of the methods of FIG. 12A and FIG. 12B may further comprise positioning the gain medium 410 between the first end mirror 430 and the centre of the optical cavity 440 such that a distance between the gain medium 410 and the first end mirror 430 is about 0.8 mm or more, and/or about 1.4 mm or less. Either of the methods of FIG. 12A and FIG. 12B may further comprise adjusting the position of the gain medium 410 within the optical cavity 440.

Either of the methods of FIG. 12A and FIG. 12B may further comprise controlling an operating parameter of the gain medium 410 and/or the nonlinear optical element 420 to at least partially determine a form of at least one of the first and second peaks. Either of the methods of FIG. 12A and FIG. 12B may further comprise providing pumping electromagnetic radiation 474 to optically pump the gain medium 410. The operating parameter may comprise an absorbed pump power of the gain medium 410. The operating parameter may comprise a temperature of the gain medium 410. The operating parameter may comprise a temperature of the nonlinear optical element 420.

Either of the methods of FIG. 12A and FIG. 12B may further comprise measuring a value that is indicative of a coherence of the output electromagnetic radiation 450. The method may further comprise controlling the operating parameter such that the value is in a predetermined range. The value may be a first contrast ratio minimum of the coherence curve.

Either of the methods of FIG. 12A and FIG. 12B may further comprise introducing an angle between an optical axis 422 of the nonlinear optical element 420 and a propagation axis of the electromagnetic radiation 415 to at least partially determine a form of at least one of the first and second peaks. Either of the methods of FIG. 12A and FIG. 12B may further comprise adjusting the angle between the optical axis 422 of the nonlinear optical element 420 and the propagation axis of the electromagnetic radiation 415.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Where the context allows, embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic storage media; optical storage media; flash memory devices; electrical, optical, acoustical or other forms of propagated signals (e.g. carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. and in doing that may cause actuators or other devices to interact with the physical world.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure that are contemplated as falling within the scope of the appended claims. Each feature disclosed or illustrated in the present specification may be incorporated in any embodiments, whether alone or in any appropriate combination with any other feature disclosed or illustrated herein.

1. A laser system comprising:
a gain medium configured to amplify incident electromagnetic radiation; and,
a nonlinear optical element configured to convert electromagnetic radiation amplified by the gain medium to a shorter wavelength,
wherein the laser system is configured to introduce mode competition and nonlinear effects such that the nonlinear optical element produces output electromagnetic radiation having a frequency spectrum comprising:
a first peak formed of a first group of frequencies;
a second peak formed of a second group of frequencies; and
a trough that separates the first and second peaks,
wherein the first and second peaks are the only dominant peaks in the frequency spectrum.

2. A laser system comprising:
a gain medium configured to amplify incident electromagnetic radiation; and,
a nonlinear optical element configured to convert electromagnetic radiation amplified by the gain medium to a shorter wavelength,
wherein the laser system is configured such that the nonlinear optical element produces output electromagnetic radiation having a coherence curve comprising a contrast ratio of less than about 0.1 at an optical path difference that is within the inclusive range of about 1.5 mm to about 2.5 mm.

3. The laser system of claim 1, wherein the laser system is a continuous wave laser system.

4. The laser system of claim 1, further comprising first and second end mirrors arranged to form an optical cavity containing the gain medium and the nonlinear optical element.

5. The laser system of claim 4, wherein the gain medium is positioned between the first end mirror and a centre of the optical cavity such that a gap between the gain medium and the first end mirror is smaller than a gap between the gain medium and the centre of the optical cavity.

6. The laser system of claim 5, wherein the gap between the gain medium and the first end mirror is about 0.8 mm or more.

7. The laser system of claim 5, wherein the gap between the gain medium and the first end mirror is about 1.4 mm or less.

8. The laser system of claim 1, further comprising an actuator configured to adjust the position of the gain medium within the optical cavity.

9. The laser system of claim 1, further comprising a controller configured to control an operating parameter of the gain medium and/or the nonlinear optical element to at least partially determine a form of at least one of the first and second peaks.

10. The laser system of claim 9, further comprising an optical pump source configured to provide pump electromagnetic radiation to the gain medium, wherein the controller is configured to control the optical pump source and wherein the operating parameter comprises a wavelength of the pump electromagnetic radiation.

11. The laser system of claim 1, wherein the gain medium is configured to absorb between about 2 W and about 7 W of the pumping electromagnetic radiation.

12. The laser system of claim 9, further comprising a heating system configured to adjust a temperature of the gain medium, wherein the controller is configured to control the heating system and wherein the operating parameter comprises the temperature of the gain medium.

13. The laser system of claim 12, wherein the controller is configured to set the temperature of the gain medium to between about 40° C. and about 80° C.

14. The laser system of claim 9, further comprising a heater configured to adjust a temperature of the nonlinear optical element, wherein the controller is configured to control the heater and wherein the operating parameter comprises the temperature of the nonlinear optical element.

15. The laser system of claim 14, wherein the controller is configured to set the temperature of the nonlinear optical element to between about 35° C. and about 55° C.

16. The laser system of claim 9, further comprising a spectrometer configured to measure a value that is indicative of a coherence of the output electromagnetic radiation, wherein the controller is configured to control the operating parameter such that the value is in a predetermined range.

17. The laser system of claim 1, wherein an angle between an optical axis of the nonlinear optical element and a propagation axis of electromagnetic radiation incident on the nonlinear optical element is configured to at least partially determine a form of at least one of the first and second peaks.

18. The laser system of claim 17, further comprising an actuation system configured to adjust the angle between the optical axis of the nonlinear optical element and the propagation axis of the electromagnetic radiation.

19. The laser system of claim 3, wherein at least one of the first and second end mirrors comprises a concave reflective surface configured to reflect the electromagnetic radiation.

20. The laser system of claim 1, wherein the gain medium comprises one of the following crystals:
Nd:YVO4, Nd:GdVO4, Nd:YAG, Nd:YAP, Nd:YLF, Nd:KGW.

21. The laser system of claim 1, wherein the gain medium is elongate along its optical axis.

22. The laser system of claim 1, wherein the gain medium has a length along its optical axis of between about 4 mm and about 7 mm.

23. The laser system of claim 1, wherein the gain medium comprises one of the following dopants: Nd, Yb, Pr, Er.

24. A method of operating a laser system comprising:
using a gain medium to amplify incident electromagnetic radiation;
using a nonlinear optical element to convert electromagnetic radiation amplified by the gain medium to a shorter wavelength; and
configuring the laser system to introduce mode competition and nonlinear effects such that the nonlinear optical element produces output electromagnetic radiation having a frequency spectrum comprising:
a first peak formed of a first group of frequencies;
a second peak formed of a second group of frequencies; and
a trough that separates the first and second peaks,
wherein the first and second peaks are the only dominant peaks in the frequency spectrum.

25. A method of operating a laser system comprising:
using a gain medium to amplify incident electromagnetic radiation;
using a nonlinear optical element to convert electromagnetic radiation amplified by the gain medium to a shorter wavelength; and,
configuring the laser system such that the nonlinear optical element produces output electromagnetic radiation having a coherence curve comprising a contrast ratio of less than about 0.1 at an optical path difference that is within the inclusive range of about 1.5 mm to about 2.5 mm.

26. The method of claim 24, further comprising operating the laser system using continuous wave operation.

27. The method of claim 24, further comprising arranging first and second end mirrors to form an optical cavity containing the gain medium and the nonlinear optical element.

28. The method of claim 27, further comprising positioning the gain medium between the first end mirror and a centre of the optical cavity such that a gap between the gain medium and the first end mirror is smaller than a gap between the gain medium and the centre of the optical cavity.

29. The method of claim 28, wherein the gap between the gain medium and the first end mirror is about 0.8 mm or more.

30. The method of claim 28, wherein the gap between the gain medium and the first end mirror is about 1.4 mm or less.

31. The method of claim 27, further comprising adjusting the position of the gain medium within the optical cavity.

32. The method of claim 24, further comprising controlling an operating parameter of the gain medium and/or the nonlinear optical element to at least partially determine a form of at least one of the first and second peaks.

33. The method of claim 32, further comprising providing pumping electromagnetic radiation to optically pump the gain medium, wherein the operating parameter comprises a wavelength of the pump electromagnetic radiation.

34. The method of claim 32, wherein the operating parameter comprises a temperature of the gain medium.

35. The method of claim 32, wherein the operating parameter comprises a temperature of the nonlinear optical element.

36. The method of claim 32, comprising:
measuring a value that is indicative of a coherence property of the output electromagnetic radiation; and,
controlling the operating parameter such that the value is in a predetermined range.

37. The method of claim 24, further comprising introducing an angle between an optical axis of the nonlinear optical element and a propagation axis of the electromagnetic radiation to at least partially determine a form of at least one of the first and second peaks.

38. The method of claim 37, further comprising adjusting the angle between the optical axis of the nonlinear optical element and the propagation axis of the electromagnetic radiation.
